(19) United States
(12) Patent Application Publication
(10) Pub. No.: US 2008/0317927 A1
(43) Pub. Date: Dec. 25, 2008

(54) Process for Treatment of Kappa Carrageenan

(75) Inventor: Jens Eskil Trudso, Roskilde (DK)

Correspondence Address: J M HUBER CORPORATION, 333 THORNALL STREET, PATENT DEPARTMENT, EDISON, NJ, 08837-2220, US

(73) Assignee: CP KELCO U.S., INC., Atlanta, GA (US)

(21) Appl. No.: 11/767,693

(22) Filed: Jun. 25, 2007

(51) Int. Cl. A23L 1/05

(52) U.S. Cl. 426/575

(57) ABSTRACT

The present invention discloses A process for producing a carrageenan composition, comprising the steps of: cleaning kappa carrageenan-containing seaweed in water; treating the cleaned seaweed with an aqueous treatment solution, the aqueous treatment solution containing about 3-30 wt %. preferably 10-25 wt %. and most preferably 15-20 wt %, of a treatment compound; subjecting the treated seaweed to washing with water; and processing the washed seaweed to produce the carrageenan composition.

### BACKGROUND OF THE INVENTION

Production of carrageenan can be traced back to Ireland where plants of the red seaweed algae species chondrus crispus were first harvested with rakes during low tide or by gathering seaweed that had washed ashore. After harvesting, the weeds were typically washed, sun-bleached, dried and boiled with milk to form a pudding. The weeds themselves were dubbed “Irish Moss” and after making it familiar to most of Europe, Nineteenth Century Irish immigrants carried it to the U.S. and Canada as well.

Today, this seaweed pudding is mostly confined to Ireland's cultural history, but carrageenan has become much more important because of its effectiveness as a functional food additive in forming gels in an aqueous system, which make it useful in a wide variety of applications, including beer (in which it has been used for over 150 years as a fining) to processed meat and food products like milk drinks and deserts; pharmaceutical preparations such as orally-administered gelcaps; personal care products such as toothpaste and skin care care preparations; and household products such air-freshener gel and cleaning gels. The temperature at which carrageenan gels and melts is dependent on a number of factors that include especially the concentration of gelling cations such as potassium and calcium ions. Generally speaking, the higher the concentration of gelling cations the higher the gelling and melting temperature of the carrageenan. Such cations may come not only from the composition to which the carrageenan is added as a gelling agent, but also from the carrageenan itself.

Thus, carrageenans with relatively high gelling cation concentrations also require relatively high-temperature processing. Generally, lower temperature processes are preferred since these save processing time, are less expensive and don't negatively affect the preparation of the composition in which the carrageenan is being included—this is especially important for food compositions, where higher temperatures may impair the base foodstuffs that are included in the food product. Thus, in order to produce carrageenan materials that promote gelling at even lower temperatures there is a continuing need for carrageenan extraction methods that reduce the concentration of gelling cations in the carrageenan.

Contemporary methods of carrageenan extraction and production have advanced considerably in the last fifty years. Perhaps most significantly is that today, rather than being gathered from wild-grown seaweed, carrageenan-containing plants such as Kappaphycus cottonii (Kappaphycus alvarezii), Euchema spinosum (Euchema denticulatum), and the above mentioned Chondrus crispus are more commonly seeded along nylon ropes and harvested in massive aqua-culture farming operations particularly in parts of the Mediterranean and throughout much of the Indian Ocean and along the Asian Pacific Ocean Coastline. Just as in the Nineteenth-century process, in contemporary processes before further processing the seaweed raw materials are first thoroughly cleaned in water to remove impurities and then dried. Then, as described in U.S. Pat. No. 3,094,517 to Stanley et al. the carrageenan is extracted from the cleaned seaweed while also at the same time being subjected to alkali modification by placing the seaweed in solution made slightly alkaline by the addition of a low concentration of alkali salt (i.e., a pH of the solution is raised to a range of, e.g., 9-10) and then heating this solution to a temperature of around 80° C. for a period of time of about 20 minutes to as long as two hours.

Subjecting the carrageenan-containing seaweed to alkali modification has the desired result of reducing the gelling cation concentration in the resulting carrageenan product; however, the extent to which the gelling cation levels can be reduced is limited because only relatively low concentrations of alkali may be used so as to not depolymerise (and thus damage) the carrageenan in the seaweed. So even though the gelling cation concentrations are reduced, they still remain high.

For example, when an alkali modification process is NOT used, typical cation concentration levels in kappa carrageenan are:
Potassium: About 5%
Calcium: About 0.4%
Magnesium: About 0.5%
Sodium: About 2%

When an alkali modification step is used to reduce these gelling cation concentrations, such as in U.S. Pat. No. 3,094,517 (Stanley et al.), which makes use of calcium hydroxide as alkali modification agent, the resulting cation concentration levels are:
Potassium: About 5%
Calcium: About 2%
Magnesium: About 0.01%
Sodium: About 1%

As can be seen, the alkali modification step taught in U.S. Pat. No. 3,094,517 significantly reduced the levels of magnesium and sodium ions, but not other gelling cations such as potassium and calcium.

Given the foregoing there is a need in the art for a process for reducing the concentration of gelling cations, and thereby lowering the gelling and melting temperatures, without depolymerising the carrageenan or damaging it in some other way.

### BRIEF SUMMARY OF THE INVENTION

Disclosed in the present invention is a process for producing a carrageenan composition, comprising the steps of: cleaning kappa carrageenan-containing seaweed in water; treating the cleaned seaweed with an aqueous treatment solution, the aqueous treatment solution containing about 3-30 wt %, preferably 10-25 wt %, and most preferably 15-20 wt %, of a treatment compound; subjecting the treated seaweed to washing with water; and processing the washed seaweed to produce the carrageenan composition.

Also disclosed in the present invention is a process for producing a carrageenan composition, comprising the steps of: cleaning the kappa carrageenan-containing seaweed in water; treating, in a first treating step, the washed seaweed with an aqueous treatment solution, the aqueous treatment solution containing about 3-30 wt %, preferably about 10-25 wt %, and most preferably about 15-20 wt %, of an alkali; rinsing the treated seaweed to remove excess of the first treatment compound; treating, in a second treating step, the rinsed seaweed with a second aqueous treatment solution, the second aqueous treatment solution containing about 3-30 wt %, preferably about 10-25 wt %, and most preferably about 15-20 wt % of a salt to form a seaweed preproduct; washing the seaweed preproduct in water or a mixture of water and alcohol; and drying the washed seaweed preproduct to produce a carrageenan composition.

### BRIEF DESCRIPTION OF THE SEVERAL VIEWS OF THE DRAWINGS

The foregoing summary; as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 shows the effect of the temperature of the post-treatment cleaning solution on the product yield.

FIG. 2 shows the effect of the cleaning temperature on gelling and melting temperatures.

FIG. 3 shows the effect of the number of cleaning steps on yield index.

FIG. 4 shows the effect of the number of cleaning steps on gelling and melting temperatures.

FIG. 5 shows the effect of ethanol concentration during washing on the yield.

FIG. 6 shows the effect of ethanol concentration during washing on gelling and melting temperatures.

FIG. 7 shows the effect of the alkali treatment time on the yield.

FIG. 8 shows the effect of the alkali treatment time on gelling and melting temperatures.

FIG. 9 shows the effect of the alkali type on yield.

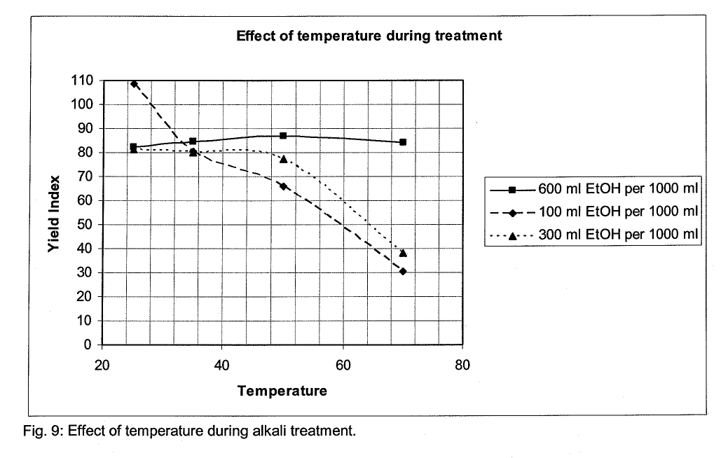

FIG. 10 shows the effect of treatment with calcium hydroxide on yield.

FIG. 11 shows the effect of calcium hydroxide treatment time on gelling and melting temperatures.

FIG. 12 shows the effect of sodium chloride treatment time on yield.

FIG. 13 shows the effect of sodium chloride treatment time on gelling and melting temperatures.

FIG. 14 shows the effect, of various salts on the yield index.

FIG. 15 shows the effect of various salts on gelling and melting temperatures.

FIG. 16 shows the effect of treatment with alkali and salt on the yield.

FIG. 17 shows the effect of the alcohol concentration during alkali treatment on the yield.

FIG. 18 shows the effect of the alcohol concentration during alkali treatment on gelling and melting temperatures.

FIG. 19 shows the effect of the temperature during alkali treatment at various concentration of alcohol on yield index.

FIG. 20 shows the effect of the temperature during alkali treatment at various concentrations of alcohol on gelling and melting temperatures.

FIG. 21 shows the effect of treatment time on gelling and melting temperatures.

FIG. 22 shows the effect of treatment on gelling and melting temperatures.

FIG. 23 shows the effect of alkali treatment time on yield index.

FIG. 24 shows the effect of alkali treatment time on gel strength and break strength.

FIG. 25 shows the effect of longer alkali treatment times on gelling, melting and dissolution temperature.

FIG. 26 shows a temperature sweep graph.

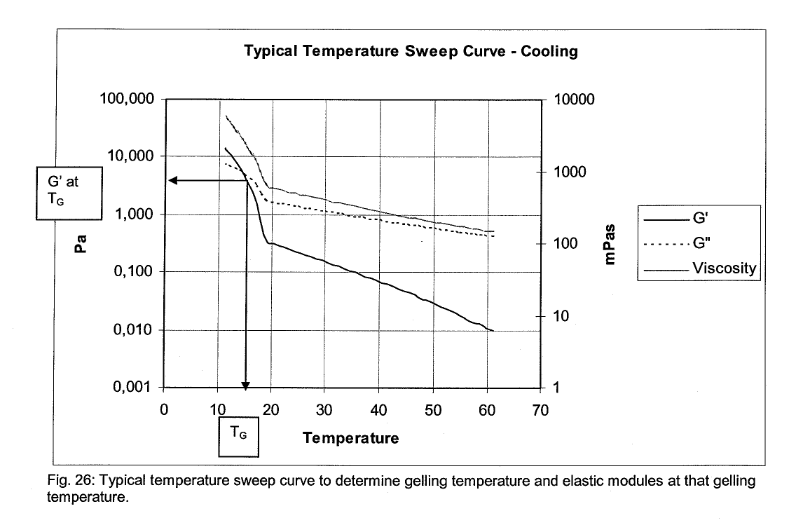

FIG. 27 shows a temperature sweep graph.

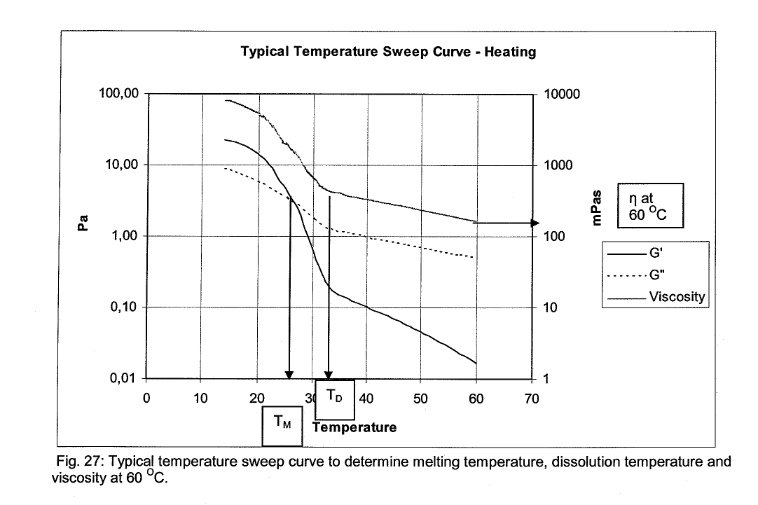

### DETAILED DESCRIPTION OF THE INVENTION

All parts, percentages and ratios used herein are expressed by weight unless otherwise specified. All documents cited herein are incorporated by reference.

By “alkali” it is meant a base according to the Brønsted-Lowry definition, i.e., an alkali is a molecule or ion that accepts a proton in a proton-transfer reaction.

The present invention is directed to kappa carrageenans, which may be more specifically described as generic repeating galactose and 3,6-anhydrogalactose residues linked b-(1-4) and a-(1-3), respectively and with characteristic 4-linked 3,6-anhydro-a-D-galactose and 3-linked-b-D-galactose-4-sulphate groups—kappa carrageenans differ from iota carrageenans only by the presence of a single sulphate group. The molecules arrange themselves in a right-handed double helix with the strands parallel and threefold, again iota and kappa carrageenan are very similar in this regard, with kappa carrageenan forming a slightly more disordered helix. The helix is stabilized by interchain hydrogen bonds through the only unsubstituted positions at O-2 and O-6 with the sulphate groups projecting outward from the helix. As mentioned above, there is a strong correlation between the presence of gelling cations and gellation. Without being limited by theory, it is believed that gels are formed in kappa carrageenan through gelling (primarily monovalent) cations such as Na, K, Rb, Cs, NH₄, Ca²⁺ as well as some divalent cations like calcium atoms that facilitate side-by-side interaction of the strands to form a three dimensional gel network. The exact transformation mechanism from the carrageenan as randomly-oriented coils at higher temperatures to a gelled network is the subject of some dispute. As the temperature is lowered the random coils of carrageenan molecules reaggregate to form gels. In one model of gellation, a gel is created by the formation of the carrageenan molecules into double helices; in certain forms of carrageenan (such as kappa carrageenan) these double helices may themselves aggregate side-by-side due to the influence of the aforementioned gelling cations forming aggregates of double helices and eventually even forming domains of a three-dimensional ordered gel network. Alternatively it has been suggested that upon cooling the random coils of the carrageenan molecules do not form double helices but only single helix structures, and that these single helix structures form single helices in which the gelling cations nested in the bends of the helix promote intermolecular aggregation.

Accordingly, the present invention is directed towards a process for treating fresh or dried kappa carrageenan-containing seaweed so as to substantially reduce to amount of gelling cations from the kappa carrageenan in the seaweed. Of equal importance is that this treatment process reduces the gelling cation concentration without extracting the carrageenan; in other words, depleting the gelling cations of the carrageenan by performing the alkali modification process essentially in situ. By modifying the polymer in situ in the seaweed, depolymerisaton of the carrageenan polymer is avoided and a kappa carrageenan preparation is produced that forms gels having lower gelling and melting temperatures than were hitherto known.

The process for producing kappa carrageenans according to the present invention will now be described in greater detail.

The present process utilizes a first step which is a conventional cleaning step in which the carrageenan-containing seaweed, particularly seaweed of the species Eucheuma cottonii, is washed to remove impurities and unwanted particulates. The water may be sea water, tap water, rain water, deionised water, sodium chloride softened water or preferably demineralised water. Washing may be conducted at temperatures in the range 5-25° C. The washing may be conducted as a counter current wash or a batch wash, with a counter current process preferred because of its better utilisation of the treatment liquid. (In all subsequent steps of the process of the present invention, the water may be rain water, deionised water, sodium chloride softened water, but preferably demineralised water).

The second step in the process may be practiced in accordance with three different embodiments.

### (A) Second Step, First Embodiment

In the first embodiment, the second step is a treatment of the cleaned seaweed with an aqueous treatment solution containing alkali in water. The alkali provides cations, which exclude potassium, calcium and/or magnesium in the carrageenan, while the concentration of the alkali in the treatment solution is held sufficiently high to reduce the aqueous solubility of the carrageenan thus preventing it from leaching out of the seaweed and dissolving into the water during this and subsequent steps.

Accordingly, by treating the carrageenan-containing seaweed in this way, the carrageenan is depleted from its gelling cations in situ.

Preferred alkalis are sodium hydroxide and its corresponding carbonates and bicarbonates, with sodium hydroxide being the most preferred. Sodium hydroxide is particularly notable for reducing the gelling and melting temperatures of carrageenan. Also suitable is calcium hydroxide. As discussed above, the concentration of the alkali must be such to provide sufficient cations while preventing solubilization of the carrageen in the water phase; an appropriate range to accomplish this dual purpose is a concentration of alkali in range of 3-30 wt %, preferably 10-25 wt % and most preferably 15-20 wt %.

In some cases alcohol may be added to the treatment solution to further reduce the leaching out of the carrageenan from the seaweed and its dissolving into water. It is particularly important to add alcohol when relatively small quantities of the aqueous treatment liquid are used. This is because excess water initially present in the wet seaweed and also remaining from the washing step could dilute the concentration of the cations in the aqueous treatment solution to the point that the carrageenan begins to leach out. The presence of alcohol in the treatment solution helps maintain high yields, especially as the treatment temperature is increased. Preferred alcohols are methanol, ethanol and isopropyl alcohol with ethanol being most preferred. The amount of alcohol ranges from 200-800 ml alcohol per 1000 ml treatment solution, preferably 200-600 ml alcohol per 1000 ml treatment solution and most preferably 500-600 ml alcohol per 1000 ml treatment solution.

The temperature during treatment ranges from 0-70° C., preferably 5-50° C. and most preferably 5-35° C. The treatment time is in the range 10 minutes-24 hours, preferably 10 minutes-4 hours, and most preferably 15 minutes-80 minutes. Either a batch wise or counter current process may be used; although as mentioned above the counter current process is preferred because it makes better utilisation of the treatment liquid.

Carrageenan products according to the first embodiment produce gels having gelling temperatures in the range 10-20° C., preferably 10-16° C. and most preferably 10-12° C.; and melting temperatures in the range 22-36° C., preferably 22-29° C. and most preferably 22-23° C. In addition, carrageenan products according to the first embodiment are characterized by a sodium content in the range 4,720-6.960%, preferably 5.520-6.960% and most preferably 5.770-6.960%; a potassium content of 0.015%-1.820%, preferably 0.015-0.036% and most preferably 0.015-0.025%; a calcium content of 0.032-0.210%, preferably 0.032-0.134% and most preferably 0.032-0.077%; and a magnesium content of 0.037-0.210%., preferably 0.037-0.086%, and most preferably 0.037-0.066%.

### (B) Second Step, Second Embodiment

In a second embodiment of the present invention, the second step is a treatment of the washed seaweed with an aqueous treatment solution containing a salt. The effect is similar as described above with respect to the first embodiment where the salt provides monovalent cations to prevent the diffusion of potassium, calcium and magnesium ions into the carrageenan while the concentration of the sodium salt in the treatment solution is held sufficiently high to reduce the aqueous solubility of the carrageenan thus reducing its leaching out from seaweed and dissolution into water. Thus similarly as above, by treating the carrageenan-containing seaweed in this way, the carrageenan is depleted from its gelling cations in situ.

Salts include sodium salts like sodium chloride, sodium sulphate, sodium phosphate, sodium tripolyphosphate and sodium hexametaphosphate. The concentration of sodium salt in the water phase is in the range 3-30 wt %, preferably 10-25 wt %, and more preferably 15-20 wt %.

As described above in the section entitled “Second Step, First Embodiment”, alcohol may optionally be added to the treatment solution to further reduce the leaching out of the carrageenan from the seaweed and dissolving into water. Similarly, the same temperature and time parameters are used in this embodiment of the process as in the previous two mentioned above.

In this embodiment, the temperature during treatment ranges from 0-25° C., preferably 0-10° C., and more preferably 0-5° C. The treatment time is in the range 10 minutes-24 hours, preferably 10 minutes-4 hours, and most preferably 10 minutes-40 minutes. Either a batch wise or counter current process may be used; the counter current process is preferred because it makes better utilisation of the treatment liquid.

Carrageenan products according to the second embodiment produce gels having gelling temperatures in the range 9-18° C.; and melting temperatures in the range 21-34° C., preferably 21-26° C. and most preferably 21-24° C. In addition, carrageenan products according to the second embodiment are characterized by a sodium content in the range 4.390-5.730%, preferably 5.520-5.730% and most preferably 5.660-5.730%; a potassium content of 0.021-1.190%, preferably 0.021-0.090% and most preferably 0.021-0.024%; a calcium content of 0.220-0.340%, preferably 0.220-0.270% and most preferable 0.220-0.230%; and a magnesium content of 0.041-0.170%, preferable 0.041-0.061%. and most preferably 0.041-0.055%.

### (C) Second Step, Third Embodiment

In a third embodiment of the present invention, this second step is essentially split into two substeps which include a first substep of treating the washed seaweed with a first aqueous treatment solution containing about 3-30 wt %, preferably 10-25 wt %, and most preferably 15-20 wt %, of an alkali, then a second substep of treating the alkali-treated seaweed with a second aqueous treatment solution containing about 3-30 wt %, preferably 10-25 wt %, and most preferably 15-20 wt %, of a salt. (For purposes of clarity, exactness and completeness to persons of ordinary skill in the art these substeps are referred to as separate processing steps in the claims.) Suitable salt and alkali species are set forth above.

As described above in the section entitled “Second Step, First Embodiment”, alcohol may optionally be added to the treatment solution to further reduce the leaching out of the carraaeenan from the seaweed and dissolving into water. Similarly, the same temperature and time parameters are used in this embodiment of the process as in the previous two mentioned above.

Carrageenan products according to the third embodiment of the second step produce gels having gelling temperatures in the range 9-19° C., preferably 9-15° C. and most preferably 9-13° C.; and melting temperatures in the range 21-35° C., preferably 21-29° C. and most preferably 21-26° C. In addition, carrageenan products according to the third embodiment of the second step are characterized by a sodium content in the range 4.870-6.910%, preferably 5.770-6.910% and more preferably 6.010-6.910%; a potassium content of 0.014-1.180%, preferably 0.014-0.068% and more preferably 0.014-0.035%; a calcium content of 0.073-0.260%, preferably 0.073-0.200% and most preferably 0.073-0.146%; and a magnesium content of 0.010-0.290%, preferably 0.010-0.160% and more preferably 0.010-0.103%.

### (D) Second Step, Fourth Embodiment

In a third embodiment of the present invention, the second step is treating the washed seaweed with an aqueous treatment solution containing both an alkali and a salt. The solution contains about 3-15 wt %, preferably 5-15 wt %, most preferably 5-10 wt %, of an alkali, and about 3-15 wt %, preferably 5-15 wt %, and most preferably 5-10 wt % of a salt. Suitable salt and alkali species are set forth above.

As described above in the section entitled “Second Step, First Embodiment”, alcohol may optionally be added to the treatment solution to further reduce the leaching out of the carrageenan from the seaweed and dissolving into water. Similarly, the same temperature and time parameters are used in this embodiment of the process as in the previous two mentioned above.

The temperature during treatment ranges from 0-70° C., preferably 5-50° C. and most preferably 5-35° C. The treatment time is in the range 10 minutes-24 hours, preferably 10 minutes-4 hours, and most preferably 15 minutes-80 minutes. Either a batch wise or counter current process may be used; the counter current process is preferred because it makes better utilisation of the treatment liquid.

Carrageenan products according to the fourth embodiment produce gels having gelling temperatures in the range 9-19° C., preferably 9-15° C. and most preferably 9-13° C.; and melting temperatures in the range 21-35° C., preferably 21-29° C. and most preferably 21-26° C. In addition, carrageenan products according to the fourth embodiment of the second step are characterized by a sodium content in the range 4.870-6.910%, preferably 5.770-6.910% and more preferably 6.010-6.910%; a potassium content of 0.014-1.180%, preferably 0.014-0.068% and more preferably 0.014-0.035%, a calcium content of 0.073-0.260%, preferably 0.073-0.200% and most preferably 0.073-0.146%; and a magnesium content of 0.010-0,290%, preferably 0.010-0.160% and more preferably 0.010-0.103%.

In the third step in the process (which is common to all three embodiments of the second step discussed above) the treated seaweed is subjected to washing to remove the excess of the last reagent that was used in the second or treatment step. The reagent can of course be either a salt or an alkali. Washing is done with slow agitation and the number of washings is in the range 1-4, preferably 1-2, and washing time is in the range 10-30 minutes per wash, preferably 15 minutes per wash. Controlling the number of washing steps is important because the yield decreases with time (possible reasons for this are discussed below) and because the number of washing steps affects the gelling and melting temperatures (again, this is discussed in greater detail, below). As above to limit leaching out of the carrageenan from the seaweed the temperature during washing is held in the range 0-25° C., preferably 0-5° C.

In the fourth and final step of the process the treated seaweed can be dried and ground into a powder of semi-refined carrageenan products, which in addition to carrageenan also contain the cellulosic material from the seaweed.

Alternatively, pure carrageenan can be extracted from the treated seaweed in pure water, such as one of the water types described above (again demineralised water is preferred). Of primary importance is that the extraction step does not re-introduce the gelling cations. Extraction temperatures are in the range 0-90° C., preferably 25-90° C. and most preferably 50-90° C. Typically, higher extraction temperatures result in greater yields.

Other aspects of the processes for production of carrageenan according to the present invention are not particularly limited, and where necessary conventional carrageenan technology may be used. In addition to the specific steps set forth herein, processes of the present invention may further comprise additional processes typically associated with carrageenan production.

An additional important aspect of this present invention is that because the relationship between the gelling and melting temperatures and the several processing parameters has been determined with such specificity, then these temperatures can be controlled depending on the specific properties desired in the carrageenan. In other words, by specially controlling the processing parameters, a carrageenan having particular properties can be produced.

The present invention will now be explained in greater details with respect to the following several experiments. These experiments and their accompanying textual descriptions, will present detailed descriptions of the process of the present invention as well as results obtained from the experimental process. Additionally analysis of the results will be presented and supplemented by possible theoretical explanations. The following experimental equipment, materials and methods were used in carrying out the present experiments. Application of these experimental methods are introduced in the specific examples section below that illustrate the present invention and place it within the context of the prior art.

Equipment
Hobart mixer equipped with heating and cooling jacket and stirrer—Hobart N-50G produced by Hobart Corporation, USA.
Cooling unit capable of cooling to about 5° C., e.g., the Haake K10/Haake DC10 produced by Thermo Electron GmbH, Germany.
Magnetic stirrer and heater equipped with temperature control, e.g., Ikamag Ret produced by Janke & Kunkel GmbH, Germany.
Beakers, 1 litre and 2 liters.
2 liters conical flask, Büchner funnel and vacuum pump.
Filter cloth.
Rheometer—Haake RheoStress RS100 equipped with cup Z20/48 mm and rotor Z20 DIN produced by Thermo Electron GmbH, Germany.
pH-meter—PHM220 produced by Radiometer, Denmark
Analytical balance, weighing with two decimals—Sartorius Basic B3100P produced by Sartorius GmbH, Germany.
Texture analyzer TA-TX2 equipped with 2 kg, weighing cell and 0.5 inch plunger traveling with a speed of 1 mm per second into the gel.
Crystallizing dishes having diameter of about 50 mm and height of about 20 mm.

Chemicals:
Sodium chloride, analytical, Merck KGaA, Darmstadt, Germany
Calcium chloride dehydrate, analytical, Merck, Germany
Sodium hydroxide, analytical, Merck, Germany
Potassium hydroxide, analytical, Merck
Calcium hydroxide, analytical, Merck
Sodium sulphate, analytical, Merck
Sodium methyl-4-hydroxybenzoate, analytical, Merck
Potassium chloride, analytical, Merck
Tri sodium phosphate dodecahydrat, analytical, Merck
Ethanol, 96%
Methanol, 100%
Isopropyl alcohol, 100%
Potassium chloride, analytical, Merck
Glycerine, analytical, Scharlau Chemie, Barcelona, Spain
Lemon oil, H. N. Fusgaard, Roedovre, Denmark
Cremophor RH 40, BASF, Ludwigshafen, Germany

Treatment of Seaweed:
1. Seaweed was washed three times in 1 litre demineralized water and refrigerated.
2. This washed seaweed was then placed in a 2-litre beaker.
3. A treatment solution was formed by the salt or alkali was dissolved at room temperature in 1000 ml of demineralized water, and subsequently cooled to the treatment temperature.
4. Seaweed was added to the treatment solution.
5. Seaweed was treated at specific temperatures and times (see below) while being stirred.
6. Treated seaweed was washed in demineralized water at specific temperatures and times (see below).
7. The washed seaweed was extracted in 1500 ml. demineralized water at 90° C. for 1 hour.
8. The extract was filtered on diatomaceous earth.
9. The filtered extract was precipitated in three volumes 100% IPA and the precipitate was washed in 1 litre 100% IPA.
10. The washed precipitate was dried at 70° C. overnight.
11. The dry precipitate was milled on 0.25 mm screen.

The Determination of gelling and melting temperatures of carrageenan-compositions was made using a composition with the following carrageen-incorporating composition:

| Ingredients | Grams | % |
|---|---|---|
| Seaweed extract | 0.48 | 0.96 |
| Glycerine | 3.00 | 6.00 |
| Parabene | 0.05 | 0.10 |
| Demineralized | 33.75 | 67.50 |
| Water | | |
| Lemon oil | 1.25 | 2.50 |
| Isopropyl alcohol | 1.50 | 3.00 |
| Cremophor RH 40 | 10.00 | 20.00 |
| Net weight | 50.00 | 100.00 |

This composition was prepared as follows:
1. The water, glycerine and parabene were mixed.
2. The seaweed extract was dispersed in this mixture and stirred for about 60 minutes.
3. The dispersion was heated while stirring to 70° C.
4. The dispersion was then cooled to 55-60° C.
5. A hot (about 50° C.) preparation of oil, isopropyl alcohol and Cremophor RH 40 was mixed into the cooled dispersion.
6. The net weight was adjusted with hot (about 60° C.) water and cooled over night at room temperature.

The gelling and melting temperatures were measured by temperature sweeps on Haake RheoStress RS100, using cooling and heating rates of 1° C./min. The following program was generally used, however, in some instances where gelling and melting temperatures were higher; the program was run at higher starting temperatures and lower end-temperatures:
1. 65-5° C., 0,50 Pa, f=0,4640 Hz
2. 5-65° C., 0,50 Pa, f=0,4640 Hz
3. Gelling temperature is defined as the temperature during the cooling sweep, where the elastic modulus, G′ intersects with the viscous modulus, G″.
4. Melting temperature is defined as the temperature during the heating sweep, where the elastic modulus, G′ intersects with the viscous modulus, G″.

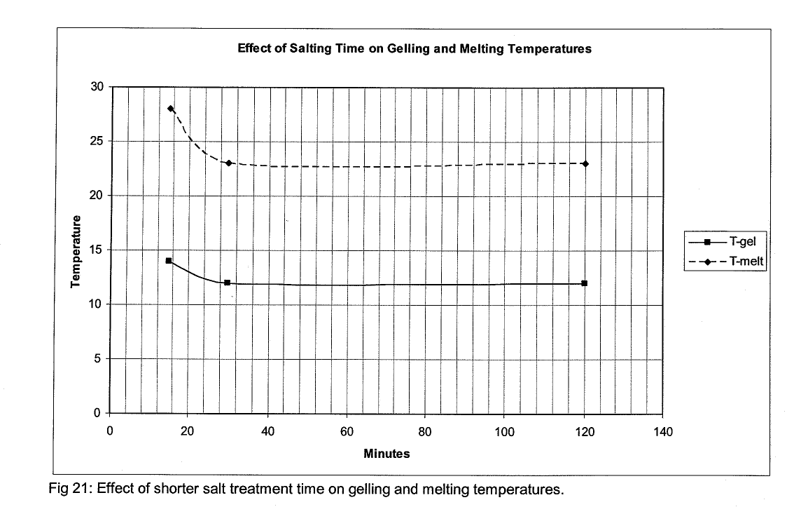

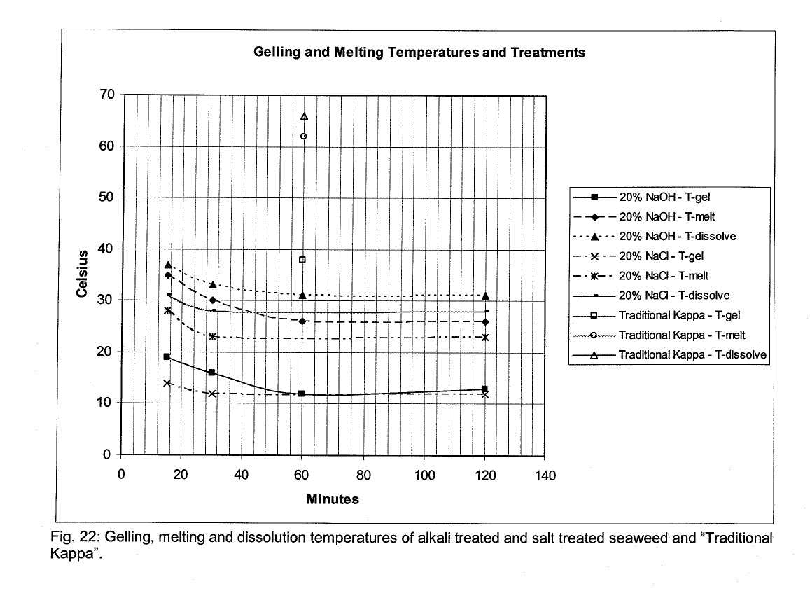

FIG. 21 and FIG. 22 show typical temperature sweep graphs. The determination of break strength and gel strength of carrageenan-compositions was made using a composition with the following carrageen-incorporating composition:

| Ingredients | Grams | % |
|---|---|---|
| Seaweed extract | 0.96 | 0.96 |
| Glycerine | 12.00 | 6.00 |
| Parabene | 0.20 | 0.10 |
| Demineralized | 134.80 | 67.40 |
| Water | | |
| Potassium chloride | 0.40 | 0.20 |
| Lemon oil | 5.00 | 2.50 |
| Isopropyl alcohol | 6.00 | 3.00 |
| Cremophor RH 40 | 40.00 | 20.00 |
| Net weight | 200.00 | 100.00 |

This composition was prepared as follows:
1. The water, glycerine, parabene and potassium chloride were mixed.
2. The seaweed extract was dispersed in this mixture and stirred for about 60 minutes.
3. The dispersion was heated while stirring to 70° C.
4. The dispersion was then cooled to 55-60° C.
5. A hot (about 50° C.) preparation of oil, isopropyl alcohol and Cremophor RH 40 was mixed into the cooled dispersion.
6. The net weight was adjusted with hot (about 60° C.) water.
7. The hot solution was poured into crystallizing dishes having adhesive tape round to brim making it possible to fill the crystallizing dish to above the brim and cooled over night at room temperature.

The break strength and gel strength were measured on Texture analyzer TA-TX2. Break strength is the load needed to break the gel and gel strength is the load needed to deform the gel by 2 mm.

The following procedure was used for gelling and melting temperatures in demineralized water:
1. The carrageenan product was added slowly at room temperature to demineralized water while stirring on magnetic stirrer. Stirring was continued until the preparation was completely lump-free.
2. The preparation was then heated while stirring on magnetic stirrer to 70° C., and left to cool at room temperature.

The following procedure for gelling and melting temperatures in demineralized water with salts:
1. The salt was dissolved in demineralized water at room temperature.
2. The carrageenan product was added slowly to the salt solution at room temperature while stirring on magnetic stirrer.
3. The preparation was then heated while stirring on magnetic stirrer to up to 90° C., and left to cool at room temperature.
   The Viscosity in Toothpaste was measured using the following equipment, chemicals, formula, and procedure:

Equipment
1. Beaker, 100,1
2. Beaker, 150 ml, height 95 mm, diameter 50 mm
3. Analytical balance
4. Laboratory scale, max load: 7000 g, precision: 0,1 g
5. Electric stirrer, Janke und Kunkel GmbH type RW20
6. Household mixer, Hobart type N-50
7. Brookfield viscosimeter RVT
8. Brookfield Helipath Stand D
9. Low temperature incubator, 25° C.
10. High temperature incubator, 50° C.
11. Thermostatically controlled water bath at 25° C., Haake F3-K
12. Nesco film
13. Stopwatch
14. Plastic lids

Chemicals
Glycerol, 100%
Dicalcium phosphate dehydrate, CaHPO4, 2H2O
Tetra sodium pyrophosphate decahydrate, Na4O7P2, 10 H2O, Sieved through a 40 mesh
Sodium chloride, NaCl

Formula

| | |
|---|---|
| Carrageenan product | 6.60 g |
| Glycerol | 220.00 g |
| Dicalcium phosphate dehydrate | 480.00 g |
| Tetra sodium pyrophosphate decahydrate | 4.20 g |
| Sodium chloride | 6.70 g |
| Deionized water | 282.50 g |
| Total | 1000.00 g |

Process
1. Carrageenan product was dispersed in glycerol in exactly 3 minutes while stirring with a propeller stirrer (200-400 rpm), which was stirred for another 10 minutes (400 rpm).
2. Additional water was added while stirring (800 rpm). And the speed increased to 1200 rpm after 5 minutes and then mixed for another 10 minutes.
3. The solution was transferred to the household mixer quantitatively.
4. The tetra sodium pyrophosphate was added during mixing (speed 1) and stirred for 5 minutes (speed 2).
5. The dicalcium phosphate dehydrate was added at speed 1 and mixed for 15 minutes (speed 2). The bowl and blade was scraped after 1, 5 and 10 minutes respectively.
6. The sodium chloride was added and mixed for 25 minutes (speed 2). The bowl and blade was scraped after 5, 10 and 15 minutes respectively while maintaining a smooth texture to the paste.
7. The paste was placed into four 150 ml beakers and covered with plastic lids making sure, that as little air as possible is introduced in the paste during filling.
8. The 4 beakers were placed in a water bath—which was pre-adjusted to 25° C.—for 1 hour—while making sure that all of the paste in the beakers was below the water level.
9. The toothpastes were covered tightly with Nesco-film.
10. Two beakers were then placed in the low-temperature incubator (adjusted to 25° C.) and two beakers were placed in a high-temperature incubator (adjusted to 50° C.).
11. After 3 days' storage, one beaker was transferred from the high-temperature incubator to a 25° C. water bath and kept there for 1 hour. Viscosity was measured 72 hours after the start of the incubation.
12. There was then a measurement of the two 3-days viscosities at 25° C. (after storage at 25° C. and 50° C., respectively) on Brookfield Viscosimeter RVT with Helipath Stand, 2.5 rpm by using the following spindles:
   Toothpaste stored at 25° C.: Spindle T-D
   Toothpaste stored at 50° C. Spindle T-E
13. Both the pointer and the zero-point were placed in the middle of the window on the Brookfield and the spindle placed just below the surface. The Brookfield and Helipath stand were started just after the spindle has run 3 times.
14. Three readings were taken for each measurement, and the relative Brookfield units were the average readings multiplied by the following spindle factors:
   Factor Spindle T-D=8
   Factor Spindle T-E=20
15. After 7 days' storage, the second beaker was transferred from the high-temperature incubator to a 25° C. water bath and kept there for 1 hour.
16. The two 7-days viscosities were measured at 25° C. (after storage at 25° C. and 50° C., respectively) and the relative Brookfield units were calculated as described in step 12.

### EXAMPLES

The invention will now be described in more detail with respect to the following non-limiting examples which were performed with the above described equipment, materials and methods.

The following Examples relate to results obtained by treating the red seaweed Eucheuma cottonii with various treatment compounds. The results obtained from the present invention were compared with comparative, prior art neutral extractions, in which the washed seaweed was extracted in demineralized water for one hour at 90° C.

T_{G} and T_{M} stand for gelling temperature and melting temperature, respectively, while T_{D} is the dissolution temperature, and η stands for intrinsic viscosity at 60° C. The “% yield” is calculated as: % yield=(g. dry precipitate×1500×100)/(g. seaweed×g. precipitated extract×seaweed dry matter). Since yield of polymer from seaweed changes with season and with seaweed harvesting location, the yield of neutral extractions of seaweed have been assigned an index of 100, and subsequent calculations of yield index utilize that baseline figure.

Several results obtained from compositions prepared according to the present invention using Eucheuma cottonii with various treatment compounds are listed below. However, first a comparative, neutral, prior art sample was obtained for washed seaweed extracted in demineralized water for one hour at 90° C.

TABLE 1

| Ex- | Sea- | Amount | Precipi- | | Yield | Na | K | Ca | Mg | | pH of | T_{G} | T_{M} | T_{D} | η |
|---|---|---|---|---|---|---|---|---|---|---|---|---|---|---|---|
| traction | weed g | precipitated g | tate g | Yield % | Index | Mg/g | Mg/g | Mg/g | Mg/g | Cl⁻ % | extract | ° C. | ° C. | ° C. | cP |
| Neutral | 50.66 | 595.50 | 3.21 | 86.37 | 100 | 18.44 | 44.13 | 3.18 | 4.33 | 0.0 | 9.25 | 32 | 51 | 53 | 300 |

Effect of alkali treatment time and concentration. The first experiment looked at the yield index as a function of alkali treatment time and concentration of the alkali. The seaweed was treated at 25° C. for different periods of time with different concentrations of sodium hydroxide, and then washed twice at 5° C. with demineralized water. G′ is the elastic modulus, which indicates the stiffness of the gel and which is measured during the cooling sweep at the point where the elastic modulus. G′ intersects with the viscous modulus, G″. For comparison, a neutral extraction provides a polymer having G′ of about 4.5 Pa. The results are set forth in Table 2, below.

TABLE 2

| | Time | | Yield | Na | K | Ca | Mg | T_{G} | T_{M} | T_{D} | η | G′ at |
|---|---|---|---|---|---|---|---|---|---|---|---|---|
| NaOH % | hours | Yield, % | Index | Mg/g | Mg/g | Mg/g | Mg/g | ° C. | ° C. | ° C. | cP | T_{G} Pa |
| 5 | 2 | 46.39 | 54 | 55.20 | 0.36 | 2.10 | 0.83 | 12 | 27 | 32 | 250 | 6.0 |
| 5 | 4 | 43.32 | 50 | 55.40 | 0.26 | 1.90 | 0.98 | 12 | 27 | 32 | 200 | 6.0 |
| 10 | 2 | 49.59 | 57 | 54.90 | 0.35 | 1.90 | 1.02 | 12 | 27 | 32 | 200 | 5.5 |
| 10 | 4 | 48.32 | 56 | 54.60 | 0.25 | 1.60 | 1.19 | 13 | 27 | 32 | 200 | 5.5 |
| 20 | 2 | 63.89 | 74 | 54.60 | 0.29 | 1.49 | 1.22 | 13 | 27 | 33 | 350 | 7.0 |
| 20 | 4 | 68.05 | 79 | 54.80 | 0.15 | 1.10 | 1.39 | 14 | 29 | 33 | 300 | 6.5 |
| 20 | 16.15 | 64.73 | 75 | 54.00 | 0.23 | 1.14 | 1.52 | 16 | 28 | 33 | 250 | 7.0 |

(% NaOH = g NaOH/100 ML Demineralised Water)

For comparative purposes an additional experiment was made in which the seaweed was treated at 5° C. The results were as follows:

TABLE 3

| | | | | | | | | | | | | G′ at |
|---|---|---|---|---|---|---|---|---|---|---|---|---|
| | Time | | Yield | Na | K | Ca | Mg | T_{G} | T_{M} | T_{D} | η | T_{G} |
| NaOH % | hours | Yield % | Index | Mg/g | Mg/g | Mg/g | Mg/g | ° C. | ° C. | ° C. | cP | Pa |
| 20 | 4 | 61.23 | 71 | 57.70 | 0.24 | 0.77 | 0.66 | 12 | 23 | 30 | 200 | 6.0 |

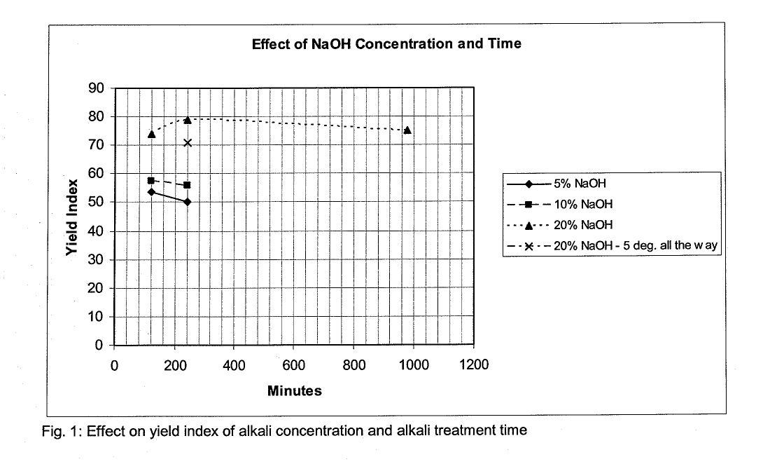

A selection of the results tabulated in Tables 2 and 3, are shown graphically in FIGS. 1-3. As shown in FIG. 1, under all treatment conditions, some loss was recorded, however, as the NaOH concentration increased the loss decreased. Even at the highest concentrations of NaOH and the lowest wash temperatures the yield was reduced, suggesting the need for alcohol in the aqueous treatment solution.

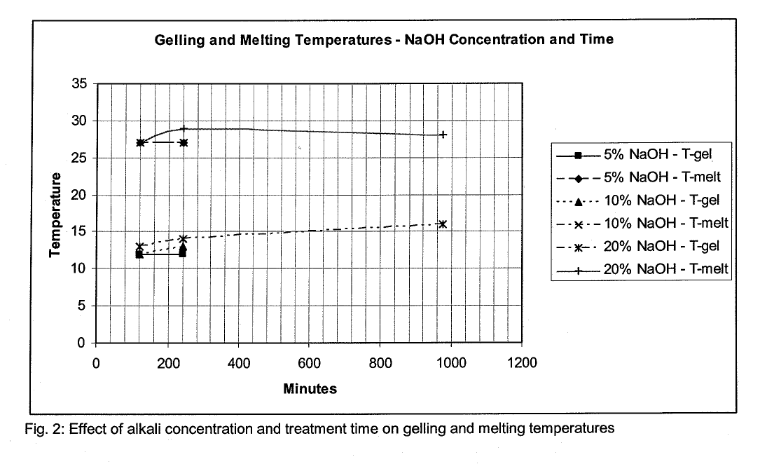

Significantly, as may also be seen in FIG. 2, gelling and melting temperatures are unaffected by alkali concentration and treatment time.

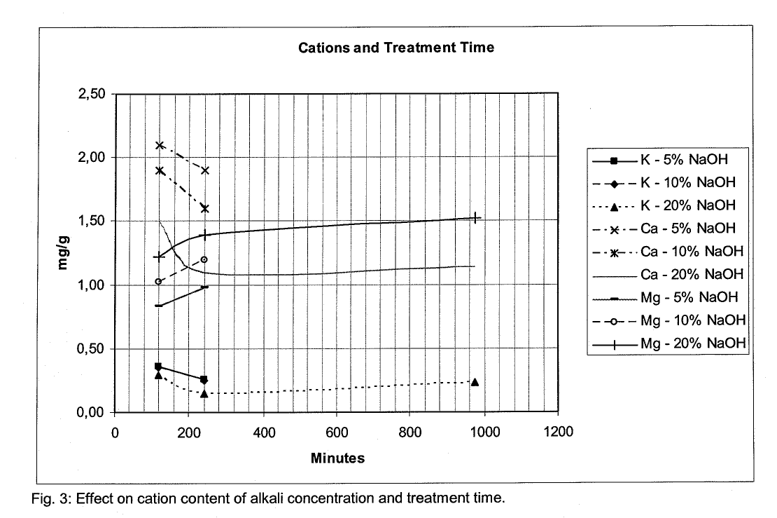

As may be seen in FIG. 3, potassium levels are also maintained at low levels, even when using low concentrations of alkali (e.g., 5% NaOH), Other cations like calcium ions show decreasing concentrations with increasing NaOH. Minimum calcium levels are obtained after treatment for about 5 hours. Increasing levels of NaOH also do not appear to reduce the magnesium levels, in fact the lowest magnesium levels were obtained when using 5% NaOH for about 2 hours, although it should be noticed from the Figures and tables that magnesium levels were still significantly lower than with a neutral extraction. It is believed that these high levels of magnesium are the result of the insolubility of Mg(OH)₂.

Effect of alcohol concentration in the wash step. Alcohol may prevent the polymer in the seaweed from dissolving, and so the effect of washing the treated seaweed in different concentrations of alcohol in demineralized water was evaluated. A new batch of Eucheuma cottonii seaweed was used and treated with 20% sodium hydroxide for 2 hours at 25° C. and then the sodium hydroxide treated seaweed was washed with a mixture of water and ethanol, the mixture having varying concentrations of ethanol. First, for comparative purposes a neutral extraction from the new batch of Eucheuma cottonii seaweed was made with the following results:

TABLE 4

| | | | | | | | | | | | | G′ |
|---|---|---|---|---|---|---|---|---|---|---|---|---|
| | | | | | | | pH | | | | | at |
| | | Na | K | Ca | Mg | | of | T_{G} | T_{M} | T_{D} | η | T_{G} |
| Extract | Yield % | Mg/g | Mg/g | Mg/g | Mg/g | Cl⁻ % | extract | ° C. | ° C. | ° C. | cP | Pa |
| Neutral | 86.45 | 22.50 | 41.50 | 3.90 | 3.8 | 0.0 | 9.10 | 31 | 50 | 52 | 320 | 3.0 |

Several other samples were then tested at varying temperatures and alcohol concentrations.

TABLE 5

| | | | ml | | | | | | | | | | | G′ |
|---|---|---|---|---|---|---|---|---|---|---|---|---|---|---|
| | | Wash | EtOH | | | | | | | | | | | at |
| | Time | temp. | per | | Yield | Na | K | Ca | Mg | T_{G} | T_{M} | η | T_{D} | T_{G} |
| NaOH % | hours | ° C. | liter | Yield % | Index | Mg/g | Mg/g | Mg/g | Mg/g | ° C. | ° C. | cP | ° C. | Pa |
| 5 | 2 | 5 | 0 | 46.39 | 54 | 55.20 | 0.36 | 2.10 | 0.83 | 12 | 27 | 250 | 32 | 6.0 |
| 5 | 2 | 5 | 100 | 68.56 | 79 | 58.00 | 0.32 | 1.52 | 0.86 | 12 | 23 | 250 | 31 | 6.0 |
| 5 | 2 | 5 | 300 | 71.67 | 83 | 58.60 | 0.44 | 1.00 | 0.65 | 11 | 23 | 220 | 30 | 6.0 |
| 5 | 2 | 5 | 600 | 66.90 | 77 | 61.00 | 0.56 | 0.54 | 0.54 | 11 | 23 | 200 | 31 | 6.0 |
| 20 | 2 | 25 | 100 | 72.35 | 84 | 58.20 | 0.17 | 0.81 | 0.67 | 12 | 25 | 270 | 32 | 6.5 |
| 20 | 2 | 25 | 300 | 72.02 | 83 | 60.60 | 0.25 | 0.52 | 0.52 | 12 | 25 | 300 | 31 | 6.0 |
| 20 | 2 | 25 | 600 | 73.23 | 85 | 69.60 | 0.36 | 0.32 | 0.40 | 13 | 27 | 200 | 32 | 5.0 |

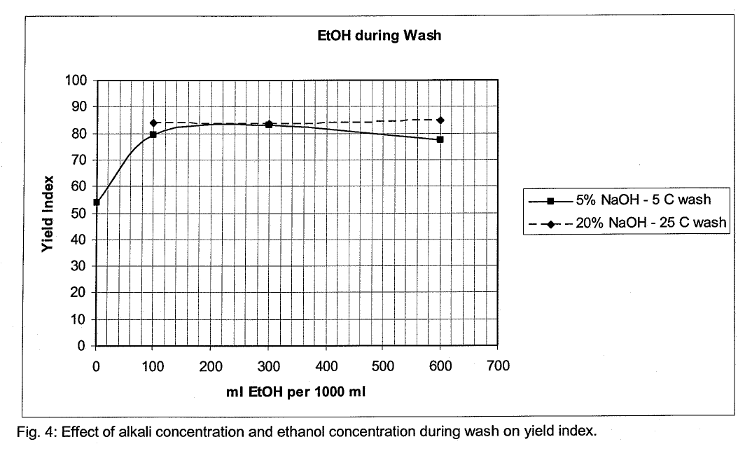

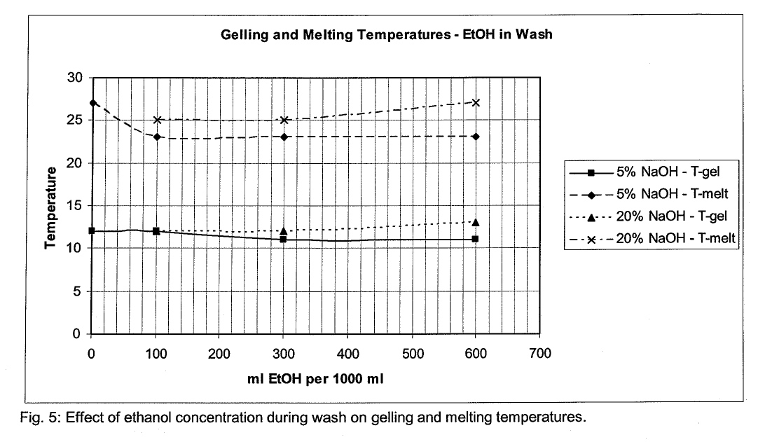

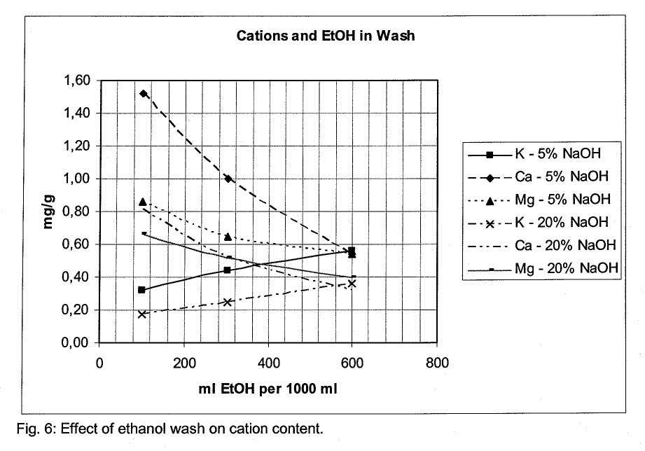

A selection of the results tabulated in Table 5, are shown graphically in FIGS. 4-6. FIG. 4 shows that irrespective of washing temperature, yield remains constant at an ethanol concentration during wash of higher than about 10 vol % ethanol. While FIG. 5 shows that gelling and melting temperatures are essentially constant with respect to the ethanol concentration during wash. However, there may be a marginal increase in these temperatures as the alkali concentration is increased during treatment. FIG. 6 shows that for calcium and magnesium, higher ethanol concentrations result in lower levels of these cations. In addition, the levels are decreased with higher concentrations of NaOH. For potassium, the levels are lower with higher NaOH concentration, but the levels increase with increasing ethanol concentration during wash.

Effect of alcohol during alkali treatment. The effect of alcohol was further studied by including alcohol during treatment of the seaweed material. The process was the same as the process used for the data in Table 5, but instead of using sodium hydroxide alkali alone, a treatment solution was made by mixing the sodium hydroxide in varying concentrations with ethanol at different temperatures. Thus, in this experiment, after being washed, the seaweed was treated for 2 hours with a mixture of diluted alkali and ethanol at 5° C. and 25° C. at the concentrations and levels given below in table 6. This treated seaweed was then washed at 5° C. with a mixture of 400 ml demineralized water and 600 ml ethanol.

TABLE 6

| | | Wash | | | | | | | | | | | | | | |
|---|---|---|---|---|---|---|---|---|---|---|---|---|---|---|---|---|
| | | Ml | | | | | | | | | | | | | | G′ |
| | | EtOH | | | | | | | | | | | | | | at |
| NaOH | Treatment | per | Seaweed | Amount | Precipitate | | Yield | Na | K | Ca | Mg | T_{G} | T_{M} | T_{D} | η | T_{G} |
| % | ° C. | liter | g | Precipitated g | g | Yield % | Index | Mg/g | Mg/g | Mg/g | Mg/g | ° C. | ° C. | ° C. | cP | Pa |
| 5 | 5 | 100 | 20.60 | 644.16 | 1.45 | 70.99 | 82 | 62.90 | 0.51 | 0.80 | 0.79 | 12 | 24 | 31 | 240 | 5.50 |
| 5 | 5 | 300 | 19.02 | 588.47 | 1.19 | 69.07 | 80 | 61.40 | 0.44 | 1.29 | 0.81 | 11 | 23 | 30 | 200 | 5.50 |
| 5 | 5 | 600 | 19.57 | 578.62 | 1.24 | 71.14 | 82 | 61.50 | 0.33 | 1.11 | 0.76 | 13 | 28 | 33 | 280 | 6.00 |
| 5 | 25 | 100 | 20.09 | 642.70 | 1.32 | 66.41 | 77 | 60.80 | 0.28 | 1.22 | 0.83 | 11 | 23 | 30 | 250 | 6.00 |
| 5 | 25 | 300 | 20.84 | 682.04 | 1.53 | 69.93 | 81 | 60.20 | 0.37 | 1.44 | 0.89 | 10 | 22 | 28 | 300 | 6.00 |
| 5 | 25 | 600 | 19.35 | 638.38 | 1.31 | 68.89 | 80 | 59.20 | 1.07 | 1.51 | 0.97 | 12 | 26 | 31 | 250 | 5.50 |
| 20 | 5 | 100 | 19.61 | 667.46 | 1.27 | 63.03 | 73 | 64.30 | 0.36 | 0.81 | 0.54 | 12 | 26 | 31 | 250 | 5.50 |
| 20 | 5 | 300 | 19.18 | 603.88 | 1.27 | 71.23 | 82 | 66.10 | 0.57 | 0.63 | 0.61 | 12 | 26 | 31 | 200 | 5.00 |
| 20 | 5 | 600 | 19.57 | 655.88 | 1.29 | 65.29 | 76 | 65.20 | 0.60 | 0.70 | 0.60 | 12 | 23 | 30 | 220 | 5.00 |
| 20 | 25 | 100 | 19.30 | 673.64 | 1.26 | 62.96 | 73 | 63.40 | 0.25 | 0.76 | 0.56 | 12 | 24 | 30 | 220 | 6.00 |
| 20 | 25 | 300 | 19.19 | 621.38 | 1.21 | 65.92 | 76 | 62.70 | 0.38 | 0.86 | 0.70 | 12 | 23 | 30 | 200 | 5.50 |
| 20 | 25 | 600 | 28.16 | 579.64 | 1.64 | 65.27 | 76 | 63.60 | 0.52 | 0.72 | 0.75 | 12 | 26 | 31 | 180 | 5.00 |

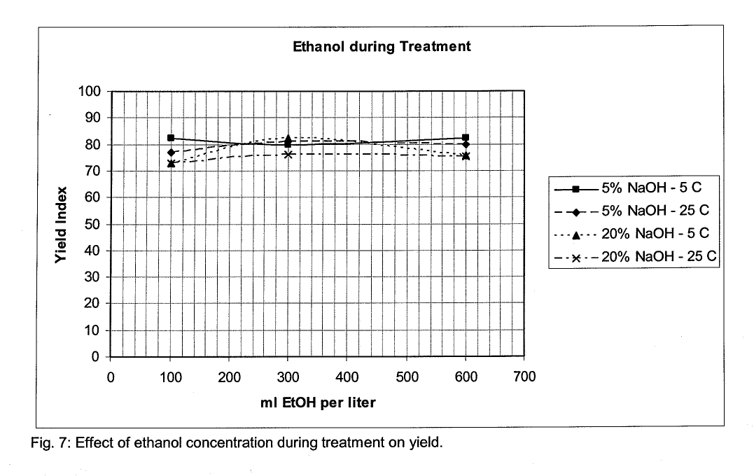

A selection of the results tabulated in Table 6 are shown graphically in FIG. 7. FIG. 7 shows that treatment at low temperature generally provides for higher yield index. The yield index appears to stay constant at ethanol concentrations higher than about 100 ml ethanol per liter. Still, there is some loss of material that apparently cannot be avoided using alcohol. As can be seen in FIG. 7, combining alcohol with the alkaline in the treatment stage does not result in a significant increase in the yield index.

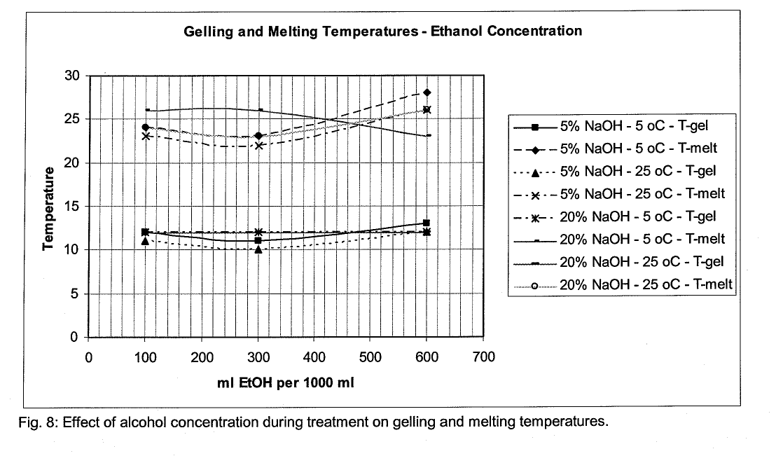

FIG. 8 shows that it is fair to conclude that neither alkali concentration nor ethanol concentration during alkali treatment affect gelling and melting temperatures to a major degree. It may be argued that as the ethanol concentration during alkali treatment increases above about 300 ml per 1000 ml, the tendency is for the gelling and melting temperatures to increase slightly.

Effect of temperature during alkali treatment. In further experiments, the effect of temperature during alkali treatment was evaluated. For this, a new batch of Eucheuma cottonii was used. First, for comparative purposes, a neutral extraction from the new batch of Eucheuma cottonii seaweed was made with the following results:

TABLE 7

| | | | | | | | | | | | | | G′ |
|---|---|---|---|---|---|---|---|---|---|---|---|---|---|
| | | | | | | | | | | | | | at |
| | | Amount | | | Na | K | Ca | Mg | T_{G} | T_{M} | T_{D} | η | T_{G} |
| Extract | Seaweed g | Precipitated g | Precipitate g | Yield % | Mg/g | Mg/g | Mg/g | Mg/g | ° C. | ° C. | ° C. | cP | Pa |
| Neutral | 20.20 | 578.20 | 1.52 | 87.15 | 30.9 | 32.4 | 5 | 2.8 | 27 | 45 | 47 | 450 | 4.0 |

Several other samples were then tested at varying temperatures and alcohol concentrations, but all with same alkali (sodium hydroxide) concentration of 20%.

TABLE 8

| Ml | | | | | | | | | | | | | | | G′ |
|---|---|---|---|---|---|---|---|---|---|---|---|---|---|---|---|
| EtOH | | | | | | | | | | | | | | | at |
| Per | Treatment | Seaweed | Amount | Precipitate | | Yield | Na | K | Ca | Mg | T_{G} | T_{M} | T_{D} | η | T_{G} |
| liter | ° C. | g | Precipitated g | g | Yield % | Index | Mg/g | Mg/g | Mg/g | Mg/g | ° C. | ° C. | ° C. | cP | Pa |
| 600 | 25 | 30.60 | 618.08 | 2.03 | 71.87 | 82 | 63.80 | 0.57 | 0.53 | 0.61 | 14 | 26 | 33 | 180 | 5.0 |
| 600 | 35 | 31.04 | 636.72 | 2.18 | 73.86 | 85 | 61.90 | 0.45 | 0.50 | 0.60 | 14 | 27 | 33 | 180 | 5.0 |
| 600 | 50 | 31.27 | 667.80 | 2.36 | 75.68 | 87 | 60.90 | 0.55 | 0.67 | 1.17 | 16 | 28 | 33 | 150 | 5.0 |
| 600 | 70 | 33.00 | 625.90 | 2.26 | 73.27 | 84 | 62.70 | 0.47 | 0.65 | 1.16 | 16 | 28 | 34 | 110 | 5.0 |
| 300 | 25 | 21.47 | 580.95 | 1.32 | 70.87 | 81 | 59.90 | 0.33 | 0.79 | 0.98 | 13 | 26 | 31 | 170 | 5.0 |
| 300 | 35 | 20.86 | 612.84 | 1.33 | 69.67 | 80 | 61.20 | 0.27 | 0.59 | 0.51 | 15 | 28 | 33 | 170 | 5.0 |
| 300 | 50 | 22.72 | 625.22 | 1.43 | 67.41 | 77 | 60.00 | 0.25 | 0.58 | 0.50 | 15 | 26 | 33 | 180 | 6.0 |
| 300 | 70 | 43.82 | 648.48 | 1.41 | 33.23 | 38 | 61.00 | 0.23 | 0.51 | 0.49 | 16 | 26 | 33 | 160 | 6.0 |
| 100 | 25 | 30.85 | 530.56 | 2.31 | 94.51 | 108 | 66.00 | 0.30 | 0.41 | 0.44 | 14 | 27 | 31 | 180 | 5.0 |
| 100 | 35 | 32.90 | 561.77 | 1.93 | 69.93 | 80 | 67.60 | 0.25 | 0.47 | 0.37 | 15 | 28 | 32 | 200 | 6.0 |
| 100 | 50 | 34.39 | 603.10 | 1.78 | 57.47 | 66 | 67.80 | 0.30 | 0.51 | 0.60 | 16 | 28 | 33 | 200 | 6.0 |
| 100 | 70 | 28.93 | 598.33 | 0.69 | 26.69 | 31 | 57.10 | 0.28 | 1.34 | 1.09 | 16 | 27 | 32 | 180 | 7.0 |

A selection of the results tabulated in Table 8, are shown graphically in FIGS. 7 and 8. FIG. 7 shows that compared to E. spinosum, E. cottonii does not get up to the same yield as a neutrally extracted equivalent. Thus, even with high concentrations of alcohol, some carrageenan from E. cottonii is lost. Thus, what happens with E. spinosum at high

treatment temperatures happens with E. cottonii at lower treatment temperatures, too. Some material must become sufficiently soluble to be leached out in the presence of high concentrations of alcohol. It is speculated that this material becomes more soluble during treatment with alkali because during treatment it becomes depolymerized to an extent where it dissolves even at a concentration of ethanol of 600 ml per 1000 ml. Between an ethanol concentration of about 300 ml per 1000 ml and 600 ml per 1000 ml, the yield index stays constant in the temperature range of about 25° C. to about 50° C. At higher temperatures, up to about 70° C., the ethanol concentration must be increased up to about 600 ml per 1000 ml.

FIG. 8 shows that increasing the temperature leads to a marginal increase in gelling and melting temperature, only. This is very different from what happens with E. Spinosum. Changing the ratio ethanol: water during alkali treatment does not appear to make a difference.

Treatment for 24 hours. A longer lasting experiment was conducted in which the washed seaweed was treated with sodium hydroxide for 24 hours at 50° C. For this, a new batch of Eucheuma cottonii seaweed was used. The seaweed was treated in a solution prepared by dissolving 80 g of sodium hydroxide in 400 ml demineralized water and 600 ml ethanol, and the seaweed was subsequently washed twice in a mixture of 400 ml demineralized wafer and 600 ml ethanol at 5° C.

First, for comparative purposes, a neutral extraction from the new batch of Eucheuma cottonii seaweed was made with the following results:

TABLE 9

| | | | | | | | | | | | | | G′ |
|---|---|---|---|---|---|---|---|---|---|---|---|---|---|
| | | | | | | | | | | | | | at |
| | | Amount | | | Na | K | Ca | Mg | T_{G} | T_{M} | T_{D} | η | T_{G} |
| Extract | Seaweed g | Precipitated g | Precipitate g | Yield % | Mg/g | Mg/g | Mg/g | g/g | ° C. | ° C. | ° C. | cP | Pa |
| Neutral | 20.20 | 578.20 | 1.52 | 87.15 | 30.9 | 32.4 | 5 | 2.8 | 27 | 45 | 47 | 450 | 4.0 |

Then an additional sample was prepared using the 24 hour procedure, the results are set forth in Table 10, below.

TABLE 10

| | | | | | | | | | | | | | | | G′ |
|---|---|---|---|---|---|---|---|---|---|---|---|---|---|---|---|
| | | | | | | | | | | | | | | | at |
| | Time | | Amount | | | Yield | Na | K | Ca | Mg | T_{G} | T_{M} | η | T_{D} | T_{G} |
| NaOH % | hours | Seaweed g | Precipitated g | Precipitate g | Yield % | Index | Mg/g | Mg/g | Mg/g | Mg/g | ° C. | ° C. | cP | ° C. | Pa |
| 20 | 24 | 41.17 | 660.74 | 3.36 | 74.23 | 94 | 63.20 | 0.94 | 0.56 | 2.10 | 18 | 34 | 40 | 38 | 2.2 |

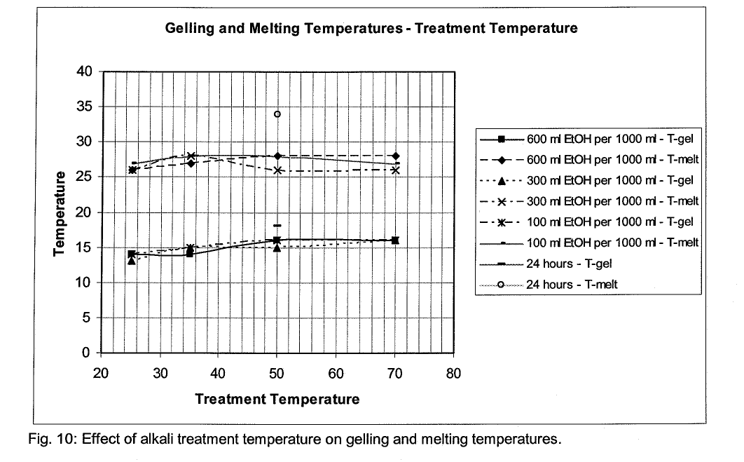

The results tabulated in Tables 9-10 are shown graphically in FIG. 10. As can be seen in FIG. 10, the treatment time can be used to control gelling and melting temperatures.

Effect of Salt Concentration and Treatment Time. The process was the same as the process used for the data in Table 13, using salt in the first wash, but while varying the temperature during alkali, treatment.

Effect of Salt and Concentration and Treatment Time. In the present invention, the seaweed material can also be treated with a salt. Accordingly, in this example the same washed seaweed as used for the data in table X was treated with salt at 25° C. and subsequently washed twice in demineralized water at 5° C. The results are set forth in Table 11, below.

TABLE 11

| | | | | | | | | | | | | | | | G′ | |
|---|---|---|---|---|---|---|---|---|---|---|---|---|---|---|---|---|
| | | | | | | | | | | | | | | pH | at | |
| | Time | | Amount | | | Yield | Na | K | Ca | Mg | T_{G} | T_{M} | η | after | T_{G} | |
| NaCl % | hours | Seaweed g | Precipitated g | Precipitate g | Yield % | Index | Mg/g | Mg/g | Mg/g | Mg/g | ° C. | ° C. | cP | extract | Pa | T_{D} ° C. |
| 0 | 0 | 50.66 | 595.50 | 3.21 | 86.37 | 100 | 18.44 | 44.13 | 3.18 | 4.33 | 32 | 51 | 300 | 9.25 | 3.0 | 53 |
| 5 | 2 | 41.46 | 565.28 | 2.10 | 72.73 | 84 | 56.20 | 0.62 | 2.70 | 0.57 | 12 | 24 | 250 | 8.77 | 6.0 | 31 |
| 5 | 4 | 40.51 | 586.97 | 2.29 | 78.17 | 91 | 56.31 | 0.61 | 2.68 | 0.50 | 12 | 24 | 200 | 9.18 | 5.0 | 31 |
| 5 | 16.4 | 42.99 | 612.75 | 2.55 | 78.57 | 91 | 55.20 | 0.90 | 2.40 | 0.46 | 12 | 25 | 250 | 9.00 | 5.5 | 31 |
| 10 | 2 | 44.40 | 637.80 | 2.67 | 76.53 | 89 | 55.80 | 0.32 | 2.40 | 0.45 | 12 | 25 | 250 | 8.75 | 6.0 | 31 |
| 10 | 4 | 40.85 | 621.64 | 2.46 | 78.63 | 91 | 55.70 | 0.37 | 2.30 | 0.45 | 12 | 23 | 300 | 8.80 | 5.5 | 30 |
| 10 | 16.4 | 42.63 | 643.12 | 2.71 | 80.23 | 93 | 56.60 | 0.36 | 2.30 | 0.41 | 12 | 26 | 350 | 9.10 | 6.5 | 32 |
| 20 | 2 | 42.28 | 708.58 | 3.00 | 81.28 | 94 | 56.00 | 0.31 | 2.20 | 0.41 | 12 | 25 | 300 | 9.20 | 6.5 | 31 |
| 20 | 4 | 42.47 | 683.64 | 2.87 | 80.23 | 93 | 56.60 | 0.29 | 2.30 | 0.41 | 12 | 24 | 300 | 9.00 | 6.0 | 31 |
| 20 | 16.55 | 42.78 | 617.16 | 2.56 | 78.70 | 91 | 56.50 | 0.21 | 2.30 | 0.43 | 12 | 24 | 300 | 8.90 | 6.0 | 30 |

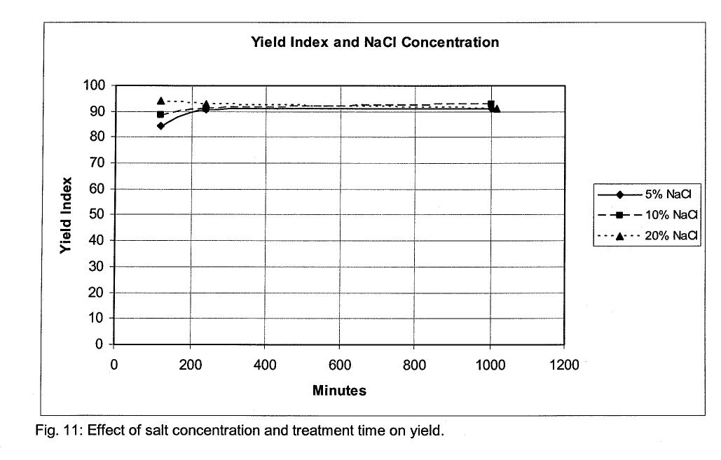

The results tabulated in Table 11 are shown graphically in FIGS. 11-13.

FIG. 11 shows that yield index stays about the same and is constant after about 4 hours' treatment with NaCl. However, with higher concentrations of NaCl, the loss in yield is lower, and with 20% NaCl, the loss is marginal. Thus, for E. Cottonii there is no absolute need for washing with a mixture of alcohol and water in order to maintain yield.

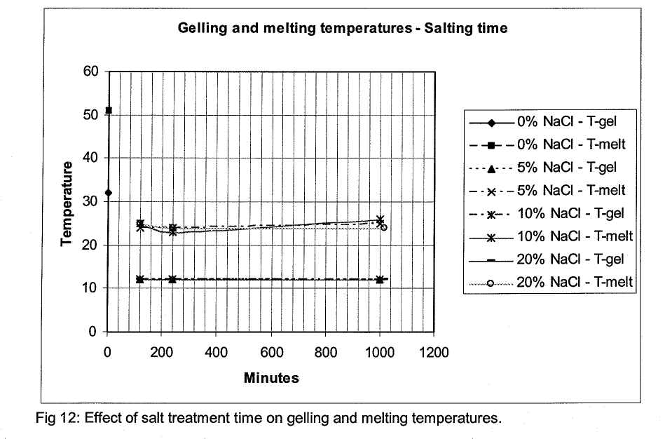

FIG. 12 shows that NaCl provides for a dramatic reduction in gelling and melting temperatures compared to a non-treated extract. Two hours is more than adequate to provide for low gelling and melting temperatures. 5% NaCl is sufficient to provide low gelling and melting temperatures.

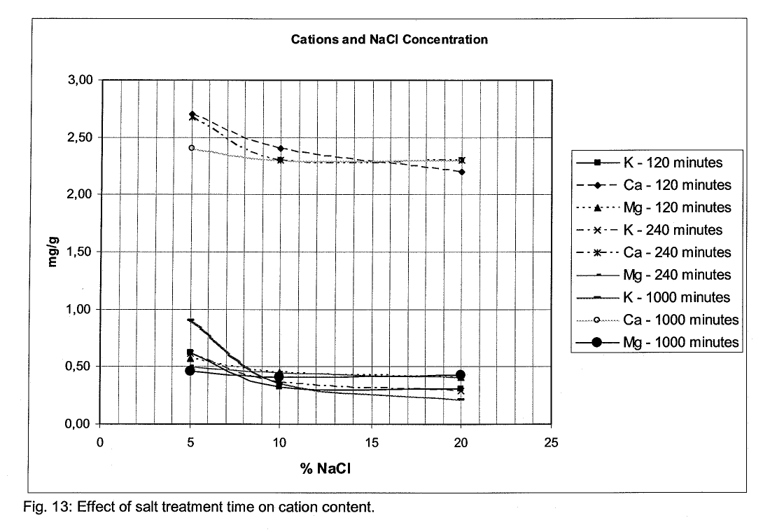

FIG. 13 shows that calcium levels are generally a factor 5 times higher than the levels of other cations. Lowest levels of cations are achieved with about 10% NaCl regardless of treatment time. Thus, shorter treatment times are needed in order to provide higher levels of cations.

Effect of alcohol during wash. In this example, the washed seaweed was treated for two hours at 25° C. with sodium chloride in demineralized water. With 5% sodium chloride in the water phase, the treated seaweed was subsequently washed twice at 5° C. with different concentrations of ethanol. With 20% sodium chloride in the water phase, the treated seaweed was subsequently washed twice at 25° C. with different concentrations of ethanol. The results are set forth in Table 12, below.

TABLE 12

| | | | | | | | | | | | | | | | | ml |
|---|---|---|---|---|---|---|---|---|---|---|---|---|---|---|---|---|
| | | | | | | | | | | | | | | | G′ | EtOH |
| | Wash | | Amount | | | Yield | Na | | Ca | Mg | T_{G} | T_{M} | T_{D} | η | aT_{G} | Per |
| NaCl % | temp. | Seaweed g | Precipitated g | Precipitate g | Yield % | Index | Mg/g | K Mg/g | Mg/g | Mg/g | ° C. | ° C. | ° C. | cP | Pa | liter |
| 5 | 5 | 42.77 | 639.60 | 2.33 | 69.13 | 80 | 54.00 | 0.98 | 2.70 | 0.53 | 12 | 26 | 33 | 330 | 6.5 | 0 |
| 5 | 5 | 43.11 | 552.91 | 2.62 | 71.41 | 83 | 55.80 | 1.11 | 2.50 | 0.55 | 12 | 24 | 30 | 550 | 6.5 | 100 |
| 5 | 5 | 41.16 | 513.16 | 2.59 | 79.66 | 92 | 55.30 | 1.41 | 2.30 | 0.51 | 12 | 26 | 31 | 430 | 6.5 | 300 |
| 5 | 5 | 40.21 | 532.88 | 2.73 | 82.77 | 96 | 55.70 | 1.69 | 2.20 | 0.44 | 12 | 24 | 31 | 400 | 6.0 | 600 |
| 20 | 25 | 43.93 | 631.44 | 2.15 | 62.91 | 73 | 55.90 | 0.27 | 2.40 | 0.43 | 12 | 26 | 31 | 350 | 7.0 | 0 |
| 20 | 25 | 33.80 | 582.73 | 2.32 | 76.52 | 89 | 55.00 | 0.96 | 2.40 | 0.50 | 13 | 28 | 32 | 450 | 6.5 | 100 |
| 20 | 25 | 33.12 | 579.73 | 2.34 | 79.17 | 92 | 55.90 | 0.33 | 2.40 | 0.45 | 12 | 26 | 31 | 450 | 6.5 | 300 |
| 20 | 25 | 33.06 | 525.65 | 2.22 | 82.99 | 96 | 57.30 | 0.24 | 2.30 | 0.41 | 12 | 25 | 31 | 300 | 6.0 | 600 |

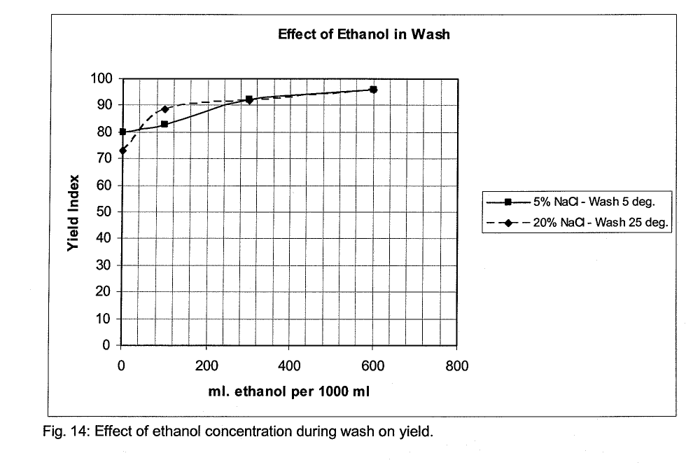

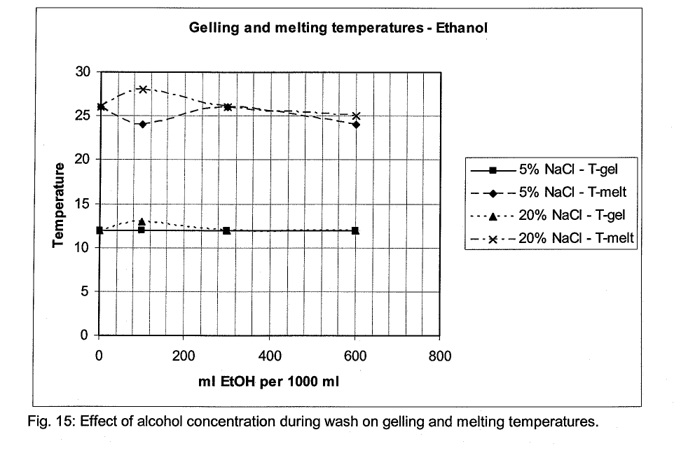

A selection of the results tabulated in Table 12, above, are shown graphically in FIGS. 14 and 15. As can be seen in these figures, at low concentrations of NaCl, washing should preferably be done at 5° C. with ethanol concentrations above about 20 vol %. At high concentrations of NaCl, washing may be done at room temperature and with ethanol concentrations at or above about 10 vol %.

Additionally, it can be seen in the figures that gelling and melting temperatures are unaffected by EtOH concentration and NaCl concentration.

In the above examples, the seaweed material was treated with either an alkali or a salt, but not both. The present invention encompasses processes in which both alkali and salt are used—both components being present simultaneously in the same treatment composition, or the process making use of sequential treatment solutions, each having either the alkali or the salt. Accordingly, the next several examples relate to the combined treatment with alkali and salt.

TABLE 13

| | | | | | | | | | | | | | | | G′ |
|---|---|---|---|---|---|---|---|---|---|---|---|---|---|---|---|
| | | | | | | | | | | | | | | | at |
| | Treatment | | Amount | | | Yield | | K | Ca | Mg | T_{G} | T_{M} | T_{D} | η | T_{G} |
| NaOH % | ° C. | Seaweed g | Precipitated g | Precipitate g | Yield % | Index | Na Mg/g | Mg/g | Mg/g | Mg/g | ° C. | ° C. | ° C. | cP | Pa |
| 20 | 5 | 33.55 | 593.57 | 2.49 | 75.14 | 95 | 60.10 | 0.29 | 1.29 | 0.66 | 11 | 24 | 30 | 380 | 6.5 |
| 20 | 25 | 36.79 | 562.46 | 2.50 | 72.60 | 92 | 59.80 | 0.25 | 0.95 | 0.66 | 13 | 26 | 31 | 110 | 5.5 |
| 20 | 35 | 37.90 | 605.72 | 2.83 | 74.08 | 94 | 58.10 | 0.20 | 1.46 | 1.22 | 14 | 25 | 31 | 240 | 6.5 |
| 20 | 50 | 39.59 | 592.01 | 2.86 | 73.33 | 93 | 57.70 | 0.17 | 1.46 | 1.80 | 15 | 24 | 31 | 200 | 6.2 |

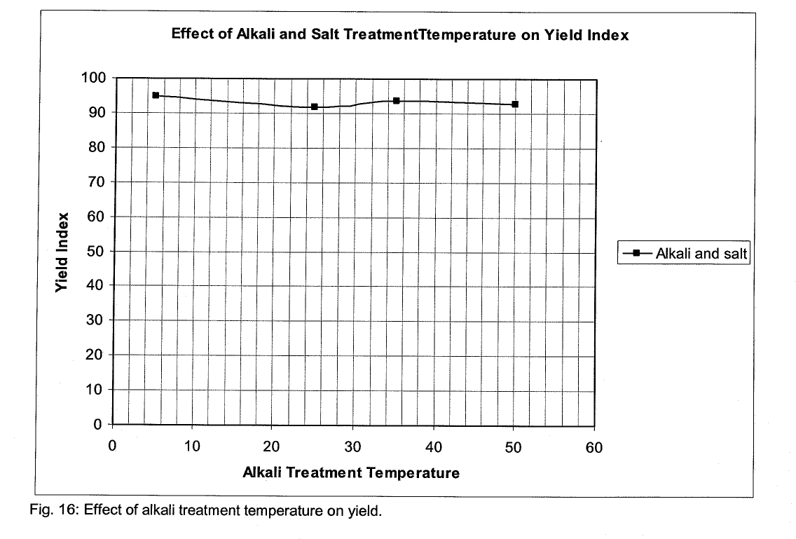

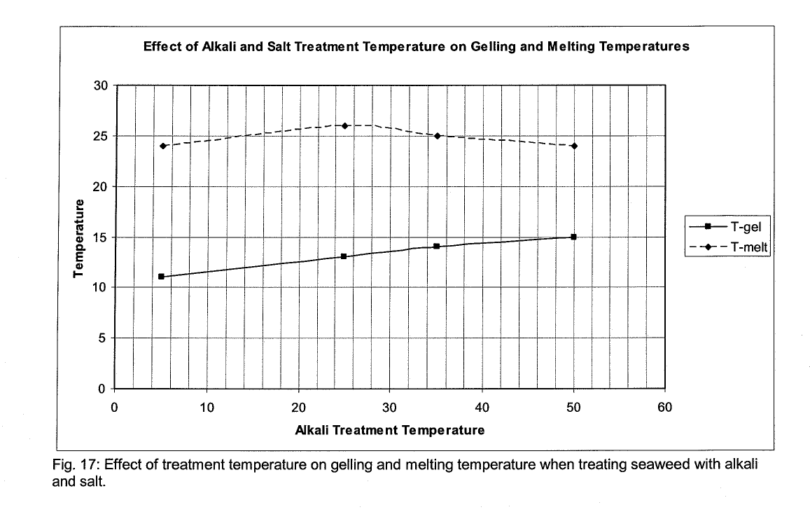

A selection of the results tabulated in Table 13, above, are shown graphically in FIGS. 16 and 17. As can be seen in FIG. 16, the yield is not influenced by the alkali treatment temperature even when the seaweed is treated with salt. There is no apparent difference between using both alkali and salt to using the alkali or salt alone.

FIG. 17 shows that the gelling temperature increases slightly with increasing alkali treatment temperature. However, the melting temperature appears to increase in about the same fashion as the gelling temperature up to an alkali treatment temperature of about 30° C. At higher alkali treatment temperatures, the melting temperature appears to decrease slightly. Again, there is no apparent difference compared to treatment with alkali or salt alone.

In these examples, the process used was similar to that of the process used to obtain the data in Table 13, except that the order of treatment was reversed so that the washed seaweed was first treated with salt and subsequently with alkali. The washed seaweed was first treated at 5° C. for two hours with 200 g sodium chloride dissolved in 1000 ml demineralized water. Next, the salt treated seaweed was treated with 80 g sodium hydroxide dissolved in a mixture of 400 ml demineralized water and 600 ml ethanol for three hours at 5° C. Lastly, the treated seaweed was washed twice in a mixture of 400 ml demineralized water and 600 ml ethanol for 15 minutes at 5° C. The results are set forth in Table 14, below.

TABLE 14

| | | | | | | | | | | | | | G′ |
|---|---|---|---|---|---|---|---|---|---|---|---|---|---|
| | | | | | | | | | | | | | At |
| | Amount | | | Yield | Na | K | Ca | Mg | T_{G} | T_{M} | η | T_{D} | T_{G} |
| Seaweed g | Precipitated g | Precipitate G | Yield % | Index | Mg/g | Mg/g | Mg/g | Mg/g | ° C. | ° C. | cP | ° C. | Pa |
| 34.43 | 636.54 | 2.79 | 76.50 | 97 | 69.10 | 0.25 | 0.73 | 0.10 | 13 | 26 | 200 | 31 | 5 |

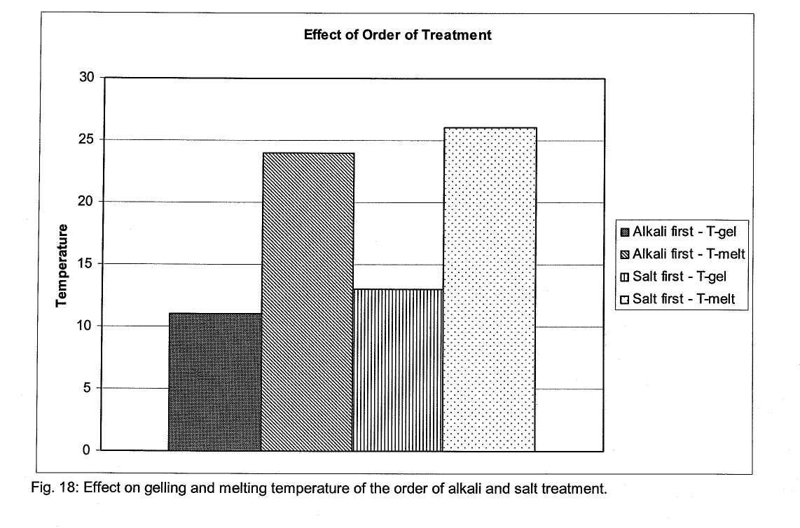

A selection of the results tabulated in Table 14, above, are shown graphically in FIG. 18. FIG. 18 shows that there appears to be slight tendency for gelling and melting temperatures to increase slightly when seaweed is first treated with salt and subsequently with alkali. However, the yield index is not changed according to the order of treatment.

Effect of Alkali treatment times. Several experiments were conducted varying the time of the alkali treatment, particularly using shorter alkali treatment. The washed seaweed was treated with 20% sodium chloride in the water phase. This corresponded to the 80 g sodium hydroxide in a mixture of 400 ml demineralized water and 600 ml ethanol used above. The treatment took place at 25° C., and subsequent to alkali treatment, the seaweed was washed twice in 60% ethanol at 25° C., which corresponded to a mixture of 120 ml demineralized water and 180 ml ethanol. The results are set forth in Table 15, below.

TABLE 15

| | | | | G′ | | | | | |
|---|---|---|---|---|---|---|---|---|---|
| Alkali | | | | At | | | | | |
| Treatment | T_{G} | T_{M} | T_{D} | T_{G} | η | Na | K | Ca | Mg |
| Minutes | ° C. | ° C. | ° C. | Pa | cP | Mg/g | Mg/g | Mg/g | Mg/g |
| 15 | 19 | 35 | 37 | 6 | 400 | 51.40 | 11.80 | 0.87 | 0.83 |
| 30 | 16 | 30 | 33 | 6.5 | 500 | 56.70 | 6.67 | 1.15 | 0.73 |
| 60 | 12 | 26 | 31 | 6.5 | 300 | 58.80 | 2.96 | 1.33 | 0.71 |
| 120 | 13 | 26 | 31 | 6.5 | 300 | 61.10 | 2.01 | 0.93 | 0.67 |

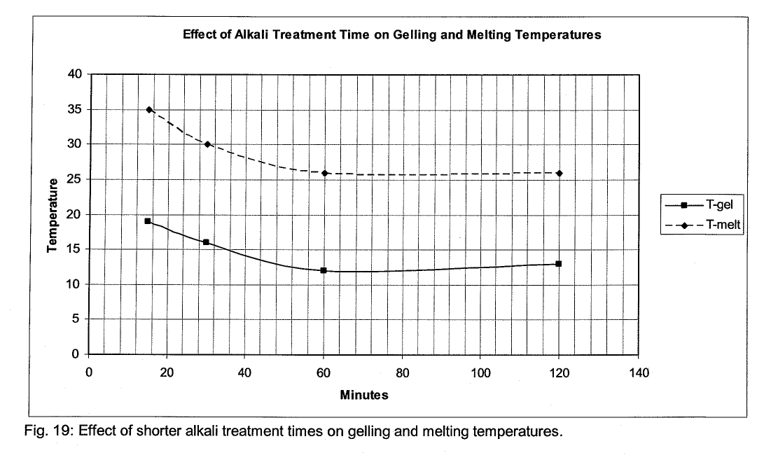

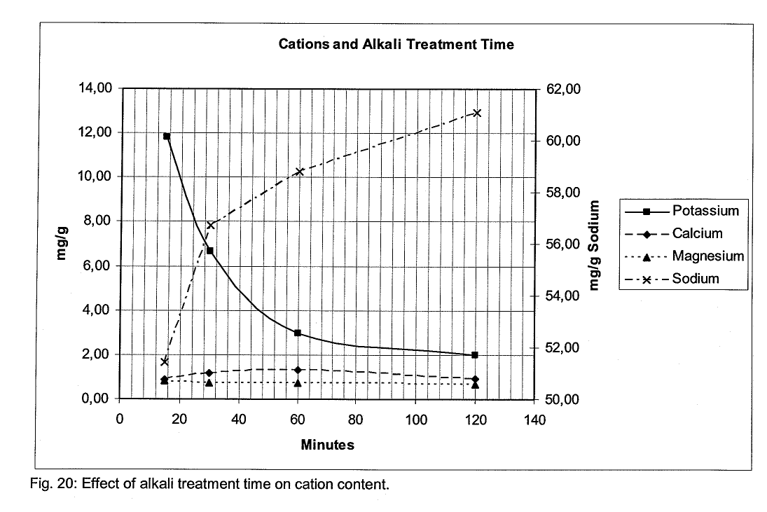

A selection of the results tabulated in Table 15, above, are shown graphically in FIGS. 19 and 20. FIG. 19 shows that the seaweed treatment time is a way to control gelling and melting temperatures in the ranges: Gelling temperature: From about 20 to about 10° C. using treatment times in the range from about 15 minutes to about 80 minutes.

The melting temperature was from about 35° C. to about 25° C. when the treatment time was in the range from about 15 minutes to about 80 minutes. FIG. 20 shows that calcium and magnesium stay unaffected by the alkali treatment time, whereas sodium increases dramatically with treatment time. Furthermore and very importantly, the gelling cation concentration, potassium, decreases substantially during the first hour of alkali treatment.

Effect of Salt treatment times. The previous experiments were then repeated using a similar procedure but substituting salt for alkali. In these experiments the washed seaweed was treated at 25° C. with a 20% sodium chloride solution, corresponding to 200 g sodium chloride dissolved in 1000 ml demineralized water. After treatment, the seaweed was washed twice as in the process used for the data in Table 15, using salt in the first wash, but while varying the temperature during alkali treatment.

TABLE 16

| Salt | | | | | |
|---|---|---|---|---|---|
| Treatment | T_{G} | T_{M} | T_{D} | G′ At T_{G} | η |
| Minutes | ° C. | ° C. | ° C. | Pa | cP |
| 15 | 14 | 28 | 31 | 7.5 | 800 |
| 30 | 12 | 23 | 28 | 7.0 | 700 |
| 120 | 12 | 23 | 28 | 7.0 | 650 |

A selection of the results tabulated in Table 16, above, are shown graphically in FIGS. 21 and 22. Specifically, FIG. 21 shows that the seaweed treatment time is a way to control gelling and melting temperatures in the ranges: Gelling temperature: From about 15 to about 10° C. using treatment times in the range from about 15 minutes to about 40 minutes. The melting temperature was in the range of about 30° C. to about 20° C. when using treatment times in the range from about 15 minutes to about 40 minutes.

FIG. 22 combines the data for gelling and melting temperatures of alkali treated seaweed, salt treated seaweed and “Traditional Kappa” seaweed. For all of these materials, the difference between gelling temperature and dissolution temperature is about 5° C.—“Traditional Kappa” results in the highest temperatures. 20% NaOH and 20% NaCl provide for substantial lower temperatures and NaCl provides for the lowest temperatures.

Effect of Alkali, Salt, and Combination of both on carrageenan used in gel air freshener formulations. As mentioned above, the present invention may also utilize treatment compositions comprising both alkali and salt. In the following experiments treatments with alkali, with salt and a combination of alkali and salt was performed to provide data relating to break strength and gel strength of air freshener gels. Treatment with alkali took place at 25° C. with 80 g sodium hydroxide dissolved in a mixture of 400 ml demineralized water and 600 ml ethanol. Traetment with salt took place at 25° C. with 200 g sodium chloride dissolved in 1000 ml demineralized water. For all treatments, washing after treatment was conducted twice at 25° C. with a mixture of 400 ml demineralized water and 600 ml ethanol. In addition, a comparison was made with a kappa carrageenan extracted from Eucheuma cottonii according to the teaching of U.S. Pat. No. 3,094,517 in combination with U.S. Pat. No. 3,907,770. This carrageenan products is termed “Traditional Kappa”. Air freshener gel are discussed in greater detail in the U.S. patent application entitled “Kappa Carrageenan” of Jens Trudsoe, filed on Jun. 22, 2007 at paragraph 0090. The results are set forth in table 17, below.

TABLE 17

| | | | | | | G′ | | | | | |
|---|---|---|---|---|---|---|---|---|---|---|---|
| | | | | | | At | | | | | |
| | Treatment | Treatment | T_{G} | T_{M} | T_{D} | T_{G} | η | Na | K | Ca | Mg |
| Sample | Minutes | with | ° C. | ° C. | ° C. | Pa | cP | Mg/g | Mg/g | Mg/g | Mg/g |
| Alkali | 15 | 20% NaOH | 18 | 34 | 37 | 6.5 | 450 | 51.1 | 11.5 | 0.69 | 0.60 |
| Alkali | 80 | 20% NaOH | 13 | 27 | 31 | 6.5 | 340 | 55.8 | 2.2 | 0.58 | 0.65 |
| Salt | 15 | 20% NaCl | 13 | 26 | 31 | 7.5 | 800 | 52 | 2 | 2.5 | 0.85 |
| Salt | 40 | 20% NaCl | 13 | 25 | 29 | 8.0 | 850 | 53.8 | 0.62 | 2.6 | 0.61 |
| Alkali and salt | 80 | 20% NaOH | 13 | 25 | 30 | 7.0 | 520 | 55.1 | 0.18 | 2 | 1.03 |
| | 40 | 20% NaCl | | | | | | | | | |
| Traditional Kappa | | | 38 | 62 | 66 | 2.0 | NA | 7.7 | 52.5 | 19.5 | 0.14 |

| | | | Air gels with KCl | | | | | |
|---|---|---|---|---|---|---|---|---|
| | | | | | | | | G′ |
| | | | | | | | | At |
| | Treatment | Treatment | | | T_{G} | T_{M} | T_{D} | T_{G} |
| Sample | Minutes | with | BS g | GS g | ° C. | ° C. | ° C. | Pa |
| Alkali | 15 | 20% NaOH | 224.50 | 51.81 | 46 | 65 | 68 | 2.0 |
| Alkali | 80 | 20% NaOH | 243.26 | 56.97 | 44 | 64 | 69 | 2.6 |
| Salt | 15 | 20% NaCl | 173.10 | 40.96 | 45 | 66 | 69 | 3.5 |
| Salt | 40 | 20% NaCl | 199.82 | 41.91 | 44 | 66 | 69 | 3.5 |
| Alkali and salt | 80 | 20% NaOH | 245.13 | 50.29 | 43 | 66 | 68 | 2.7 |
| | 40 | 20% NaCl | | | | | | |
| Traditional Kappa | | | 518.99 | 247.16 | 54 | 73 | >80 | 1.0 |

As can be seen in the data, when alkali is used, both gelling and melting temperatures decrease with increasing treatment time. With salt, however, gelling and melting temperature appear to stay constant at low values. Combination of alkali and salt reduce gelling and melting temperatures to values identical to the values obtained with salt, alone. Importantly, these temperatures are significantly lower than for a traditionally alkali modified kappa carrageenan.

Alkali treatment does increase both gel strength and break strength, and combination with salt does not change this. In all cases, however, the strengths do not come close to a traditionally alkali modified kappa carrageenan.

Effect of Alkali Treatment times. Experiments were set forth above describing the effect of treatment time (particularly, shorter treatment times) on the materials' performance. Experiments were also conducted for longer treatment times. In these experiments the washed seaweed was treated at 50° C. with 80 g sodium hydroxide dissolved in a mixture of 400 ml demineralized water and 600 ml ethanol. After alkali treatment the seaweed was washed once at 25° C. for 15 minutes with a mixture of 400 ml demineralized water and 600 ml ethanol. Then, the seaweed was treated for 40 minutes at 25° C. with 200 g sodium chloride dissolved in 1000 ml demineralized water, and lastly, the seaweed was washed twice for 15 minutes at 25° C. with a mixture of 400 ml demineralized water and 600 ml ethanol. The results are set forth in Tables 18 and 19, below.

TABLE 18

| Alkali | | | | | |
|---|---|---|---|---|---|
| Treatment | | Amount | | | Yield |
| Minutes | Seaweed g | Precipitated g | Precipitate g | Yield % | Index |
| 60 | 34.13 | 576.37 | 2.75 | 77.87 | 98 |
| 240 | 35.41 | 615.1 | 2.81 | 71.86 | 91 |
| 1440 | 34.07 | 772.42 | 3.35 | 70.90 | 90 |
| 2898.15 | 35.22 | 776.56 | 0.92 | 18.74 | 24 |

TABLE 19

| | | | | | | | | | | Air gels with KCl | | | | | |
|---|---|---|---|---|---|---|---|---|---|---|---|---|---|---|---|
| | | | | G′ | | | | | | | | | | | G′ |
| Alkali | | | | At | | | | | | | | | | | At |
| Treatment | T_{G} | T_{M} | T_{D} | T_{G} | η | Na | K | Ca | Mg | | | T_{G} | T_{M} | T_{D} | T_{G} |
| Minutes | ° C. | ° C. | ° C. | Pa | cP | Mg/g | Mg/g | Mg/g | Mg/g | BS g | GS g | ° C. | ° C. | ° C. | Pa |
| 60 | 16 | 29 | 33 | 6.8 | 300 | 53.3 | 0.26 | 2.1 | 1.6 | 579.45 | 103.07 | 47 | 68 | 72 | 2.2 |
| 240 | 16 | 29 | 34 | 5.5 | 180 | 51.1 | 0.19 | 1.8 | 1.9 | 570.75 | 123.19 | 44 | 73 | 75 | 10 |
| 1440 | 14 | 25 | 32 | 3 | 50 | 51.1 | 0.14 | 2.2 | 2.9 | 293.65 | 119.23 | 47 | 67 | 71 | 0.72 |
| 2898.15 | 15 | 29 | 35 | 2.6 | 30 | 48.7 | 0.35 | 2.5 | 1.7 | | | | | | |

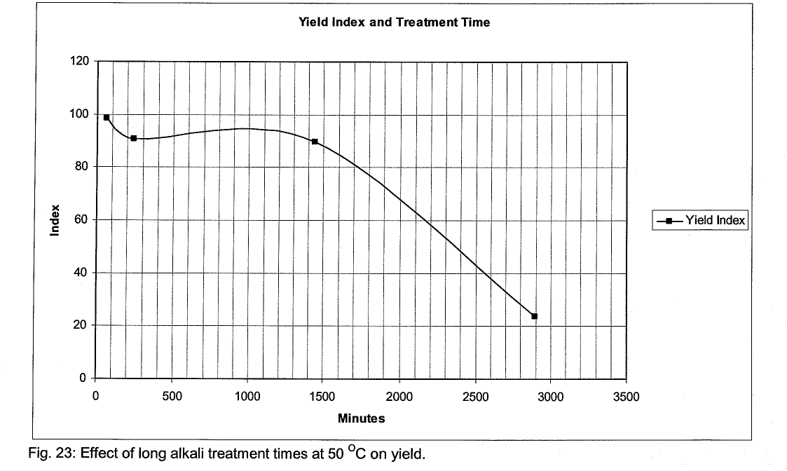

A selection of the results tabulated in the tables above are shown graphically in FIGS. 23-25. FIG. 23 shows that yield stays constant up to about 24 hours of alkali treatment at 50° C. After this, a dramatic decrease in yield results; possibly caused by alkali degradation of the carrageenan.

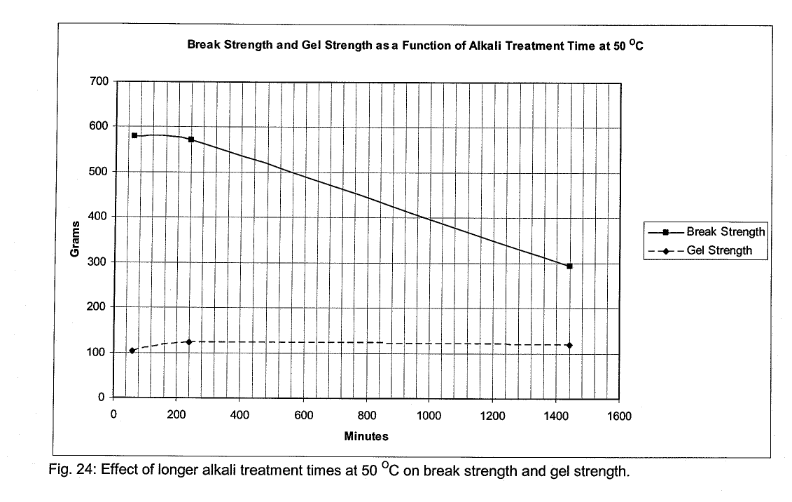

FIG. 24 shows that break strength starts to decline after about 4 hour's alkali treatment at 50° C., whereas the gel strength reaches a maximum after about 4 hour's alkali treatment at 50° C. However, it should be noted that the break strength within treatment times of up to about 4 hours are of the same order as traditional kappa carrageenan.

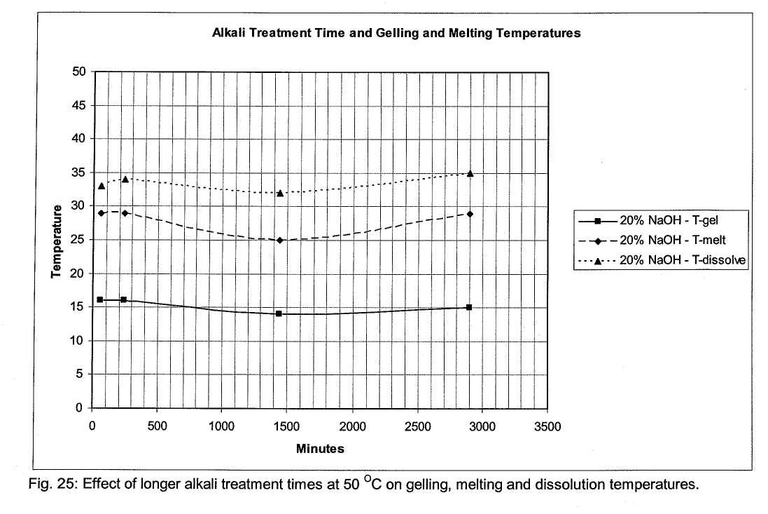

FIG. 25 shows that gelling, melting and dissolution temperatures stay pretty much unchanged regardless of treatment time at 50° C.

It will be appreciated by those skilled in the art that changes could be made to the embodiments described above without departing from the broad inventive concept thereof. It is understood therefore that this invention is not limited to the particular embodiments disclosed, but it is intended to cover modifications within the spirit and scope of the present invention as defined by the appended claims.

1. A process for producing a carrageenan composition, comprising the steps of:
cleaning kappa carrageenan-containing seaweed in water;
treating the cleaned seaweed with an aqueous treatment solution, the aqueous treatment solution containing about 3-30 wt %, preferably 10-25 wt %, and most preferably 15-20 wt %, of a treatment compound;
subjecting the treated seaweed to washing with water; and
processing the washed seaweed to produce the carrageenan composition.

2. The process according to claim 1 wherein the processing step comprises drying the washed seaweed to produce the carrageen composition in the form of semi-refined carrageenan.

3. The process according to claim 1 wherein the processing step comprises extracting the washed seaweed to produce the carrageen composition in the form of refined carrageenan.

4. The process according to claim 1, wherein the treatment compound is a salt.

5. The process according to claim 1, wherein the treatment compound is an alkali selected from the group comprising calcium hydroxide, sodium hydroxide, sodium carbonate, and sodium bicarbonate.

6. The process according to claim 4, wherein the salt is selected from the group comprising sodium chloride, sodium sulphate, sodium phosphate, sodium tripolyphosphate, and sodium hexametaphosphate.

7. The process according to claim 1 in which the treatment compound is a sodium compound selected from the group comprising sodium salts and sodium alkalis.

8. The process according to claim 1 in which the treatment compound is sodium hydroxide.

9. The process according to claim 1 in which the treatment compound comprises a sodium salt.

10. The process according to claim 1, wherein the water for washing the seaweed in the washing step is selected from the group comprising sea water, tap water, rain water, deionised water, sodium chloride softened water, and demineralised water.

11. The process according to claim 1, wherein the cleaning step is conducted at a temperature in the range 5-25° C.

12. The process according to claim 1, wherein the subjecting the treated seaweed to washing step occurs in a wash process selected from the group consisting of a batch wise wash or as a counter current wash.

13. The process according to claim 1, wherein subjecting the treated seaweed to washing step occurs in a counter current wash.

14. The process according to claim 1, wherein during the step of treating the washed seaweed, the seaweed is treated at a temperature of about 0-70° C., preferably 5-50° C., and most preferably 5-35° C.

15. The process according to claim 1, wherein during the step of treating the washed seaweed, the seaweed is treated for a time in the range 10 minutes-24 hours, preferably 10 minutes-4 hours, preferably 15 minutes-80 minutes.

16. The process according to claim 1, wherein the aqueous treatment solution further comprises alcohol in a concentration of about 20 vol % to about 80 vol %, preferably about 20 vol % to about 60 vol %, most preferably about 50 vol % to about 60 vol %.

17. The process according to claim 16 wherein the alcohol is selected from the group comprising methanol, ethanol, and isopropyl alcohol.

18. The process according to claim 1, wherein during the subjecting step, alcohol is included with the water.

19. A process for producing a carrageenan composition, comprising the steps of:
cleaning the kappa carrageenan-containing seaweed in water;
treating, in a first treating step, the washed seaweed with an aqueous treatment solution, the aqueous treatment solution containing about 3-30 wt %, preferably about 10-25 wt %, and most preferably about 15-20 wt %, of an alkali;
rinsing the treated seaweed to remove excess of the first treatment compound;
treating, in a second treating step, the rinsed seaweed with a second aqueous treatment solution, the second aqueous treatment solution containing about 3-30 wt %, preferably about 10-25 wt %, and most preferably about 15-20 wt % of a salt to form a seaweed preproduct;
washing the seaweed preproduct in water or a mixture of water and alcohol; and
drying the washed seaweed preproduct to produce a carrageenan composition.

20. The process according to claim 19, wherein the alkali is selected from the group comprising calcium hydroxide, sodium hydroxide, sodium carbonate, and sodium bicarbonate and the salt is selected from the group comprising sodium chloride, sodium sulphate, sodium phosphate, sodium tripolyphosphate, and sodium hexametaphosphate.

21. The process according to claim 19, wherein during the step of treating the washed seaweed the seaweed is treated at a temperature of about 0-25° C., preferably 0-10° C., and most preferably 0-5° C.

22. The process according to claim 19, wherein during the step of treating the washed seaweed the seaweed is treated for a time in the range of about 10 minutes-24 hours, preferably about 10 minutes-4 hours, and most preferably about 10 minutes-40 minutes.

23. The process according to claim 19, wherein the first aqueous treatment solution further comprises alcohol in a concentration of about 20 vol % to about 80 vol %, preferably about 20 vol % to about 60 vol %, more preferably about 50 vol % to about 60 vol %.

24. The process according to claim 23, wherein the alcohol is selected from the group comprising methanol, ethanol, and isopropyl alcohol.

25. A process according to claim 19, wherein the washing the seaweed preproduct step occurs in a wash process selected from the group consisting of a batch wise wash or as a counter current wash.

26. A process according to claim 19, wherein the washing the seaweed preproduct step occurs in a counter current wash.

27. A process for producing a carrageenan composition, comprising the steps of:
cleaning kappa carrageenan-containing seaweed in water;
treating the cleaned seaweed with an aqueous treatment solution, the aqueous treatment solution containing about 3-15 wt %, preferably 5-15 wt %, and most preferably 5 -10 wt %, of an alkali, and about 3-15 wt %, preferably 5-15 wt %, and most preferably 5-10 wt % of a salt;
subjecting the treated seaweed to washing with water; and
processing the washed seaweed to produce the carrageenan composition.

28. The process according to claim 27, wherein during the step of treating the washed seaweed, the seaweed is treated at a temperature of about 0-70° C., preferably 5-50° C., and most preferably 5-35° C.

29. The process according to claim 27, wherein during the step of treating the washed seaweed, the seaweed is treated for a time in the range 10 minutes-24 hours, preferably 10 minutes-4 hours, preferably 15 minutes-80 minutes.

30. The process according to claim 27, wherein the aqueous treatment solution further comprises alcohol in a concentration of about 20 vol % to about 80 vol %, preferably about 20 vol % to about 60 vol %, most preferably about 50 vol % to about 60 vol %.
